(19) United States
(12) Patent Application Publication
(10) Pub. No.: US 2026/0329220 A1
(43) Pub. Date: Oct. 22, 2026

(54) IMAGE FORMING APPARATUS

(71) Applicant: CANON KABUSHIKI KAISHA, Tokyo (JP)

(72) Inventors: NAOKI FUKUSHIMA, Shizuoka (JP); HOSU YEU, Shizuoka (JP)

(21) Appl. No.: 19/633,009

(22) Filed: Mar. 30, 2026

(30) Foreign Application Priority Data
Apr. 16, 2025 (JP) 2025-067693

(51) Int. Cl. G03G 15/00; G03G 15/10

(52) U.S. Cl. CPC G03G 15/757; G03G 15/105; G03G 15/657

(57) ABSTRACT

An image forming apparatus includes a control unit. The control unit is configured to change an amount of toner to be supplied to the contact portion by the toner supplying operation based on a detection result of the detecting unit, such that (1) a first supply amount of toner is supplied to the contact portion by the toner supplying operation in a case where a first load is applied to the motor by the conveyance member conveying a sheet in the image forming operation, and (2) a second supply amount, which is greater than the first supply amount, is supplied to the contact portion by the toner supplying operation in a case where a second load that is greater than the first load is applied to the motor by the conveyance member conveying a sheet in the image forming operation.

### BACKGROUND

### Field of the Technology

The present disclosure relates to an image forming apparatus for forming images on sheets.

### Description of the Related Art

Japanese Patent Application Laid-Open No. 2016-75768 discloses interrupting a continuous image forming job, rotating an intermediate transfer belt in a reverse direction, and removing paper dust caught between the intermediate transfer belt and a cleaning blade. Japanese Patent Application Laid-Open No. S63-172295 discloses a method of attaching toner to a photosensitive drum at sheet intervals and supplying toner to a contact portion between the cleaning blade and the photosensitive drum to thereby maintain cleaning performance.

### SUMMARY

An aspect of the present disclosure provides an image forming apparatus including a photosensitive drum configured to rotate, a transfer member configured to form a transfer portion at which a toner image is transferred from the photosensitive drum to a sheet, a cleaning member configured to come into contact with the photosensitive drum and remove toner that has not been transferred to the sheet at the transfer portion from a surface of the photosensitive drum, a conveyance member configured to convey a sheet, a motor configured to drive the conveyance member, a detecting unit configured to detect information regarding a load applied to the motor, and a control unit configured to execute (i) an image forming operation in which a toner image formed on the surface of the photosensitive drum is transferred to a sheet at the transfer portion, and (ii) a toner supplying operation which differs from the image forming operation and in which a predetermined toner image formed on the surface of the photosensitive drum is passed through the transfer portion such that toner is supplied to a contact portion between the cleaning member and the photosensitive drum, wherein the control unit is configured to change an amount of toner to be supplied to the contact portion by the toner supplying operation based on a detection result of the detecting unit, such that (1) a first supply amount of toner is supplied to the contact portion by the toner supplying operation in a case where a first load is applied to the motor by the conveyance member conveying a sheet in the image forming operation, and (2) a second supply amount, which is greater than the first supply amount, is supplied to the contact portion by the toner supplying operation in a case where a second load that is greater than the first load is applied to the motor by the conveyance member conveying a sheet in the image forming operation.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic view of an image forming apparatus according to a first embodiment, and FIG. 1B is a cross-sectional view of a process cartridge.

FIG. 2 is an enlarged view illustrating a contact portion of a cleaning blade and a photosensitive drum according to the first embodiment.

FIG. 3 is a block diagram related to control of the image forming apparatus according to the first embodiment.

FIG. 4 is a schematic view illustrating a structure of a motor according to the first embodiment.

FIG. 5 is a view illustrating a control configuration of the motor according to the first embodiment.

FIG. 6 is a view illustrating torque-current characteristics of the motor according to the first embodiment.

FIG. 7 is an explanatory view of a sheet conveyance path of the image forming apparatus according to the first embodiment.

FIG. 8 is a view illustrating an example of transition of a load torque of the motor during image formation according to the first embodiment.

FIG. 9 is a flowchart illustrating an execution sequence of an image forming job according to the first embodiment.

FIGS. 10A and 10B are each a view illustrating a sum of conveyance load torque and an execution timing of sheet interval toner purge during continuous printing in an image forming apparatus according to a second embodiment.

FIG. 11 is a flowchart illustrating an execution sequence of an image forming job according to the second embodiment.

### DESCRIPTION OF THE EMBODIMENTS

Embodiments related to the present disclosure will be described below with reference to the drawings.

### First Embodiment

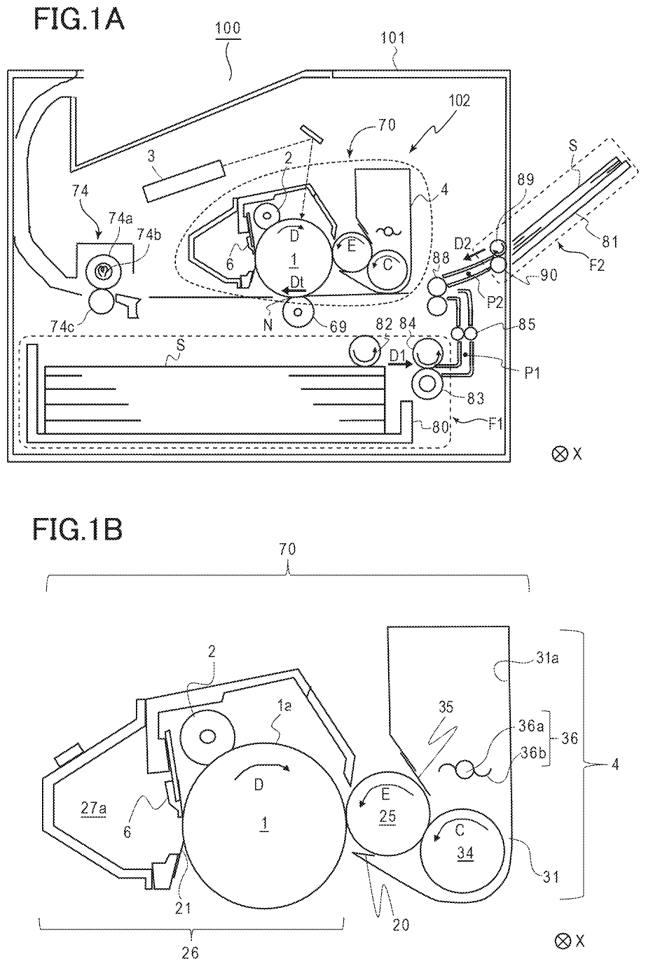

FIG. 1A is a schematic view illustrating a cross-section of an image forming apparatus 100 according to one embodiment, i.e., first embodiment. An image forming apparatus 100 is a monochrome laser printer that forms an image on a sheet S by an electrophotographic process using black toner as developer based on an image information received from an external computer. Various types of sheet members of different sizes and materials, such as paper including normal paper and thick paper, sheet members having surface treatments applied thereto such as coated paper, sheet members having special shapes such as envelopes and index paper, plastic films, and cloths, may be used as the sheet S serving as the recording material, i.e., recording medium.

The term “image forming apparatus” is not limited to a single function printer having only an image forming function, i.e., printing function, and may refer to a copying machine for copying documents, a facsimile, or a multifunction apparatus having combined such functions.

### Image Forming Apparatus

As illustrated in FIG. 1A, the image forming apparatus 100 includes an apparatus body 101, and a process cartridge 70 detachably attached to the apparatus body 101. The apparatus body 101 according to the present embodiment refers to a portion of the image forming apparatus 100 excluding the process cartridge 70.

The image forming apparatus 100 includes an image forming portion 102, a fixing portion 74, a cassette sheet feed portion F1, a manual sheet feed portion F2, and a registration roller pair 88. The image forming portion 102, the fixing portion 74, and the cassette sheet feed portion F1 are accommodated in the apparatus body 101. The above-mentioned components of the image forming apparatus 100 will be described below, but the cassette sheet feed portion F1 and the manual sheet feed portion F2 are described later.

The image forming portion 102 includes the process cartridge 70, a scanner unit 3 serving as an exposing unit, and a transfer roller 69 serving as a transfer member. The process cartridge 70 is a unit including a photosensitive drum 1 serving as an image bearing member, and at least one processing member that acts on the photosensitive drum 1 to execute respective steps of the electrophotographic process, such as charging, exposing, developing, transferring, and cleaning.

As illustrated in FIG. 1B, the process cartridge 70 according to the present embodiment includes the photosensitive drum 1, a charging roller 2 serving as a charging unit, a developing apparatus 4, and a cleaning blade 6 serving as a cleaning member. The photosensitive drum 1, the charging roller 2, and the cleaning blade 6 may be collectively referred to as a charging/cleaning unit 26 or a drum unit.

The photosensitive drum 1 is a photosensitive member for electrophotography in which a photosensitive layer including an organic photosensitive material is formed on an outer circumference portion of a cylindrical metal base. During execution of an image forming operation, i.e., during forming of image and printing, the photosensitive drum 1 is driven to rotate in an arrow D direction in the drawing.

The charging roller 2 is disposed to be in contact with a surface, i.e., outer circumference surface, of the photosensitive drum 1. An opposing portion between the photosensitive drum 1 and the charging roller 2 is referred to as a charging portion, i.e., charging position. The charging roller 2 co-rotates with the photosensitive drum 1 by a frictional force applied from a surface 1a of the photosensitive drum 1 in a state where the photosensitive drum 1 is driven. A corotron-type or scorotron-type charging device for charging the surface of the photosensitive drum 1 by performing discharge from a wire may be adopted as the charging unit.

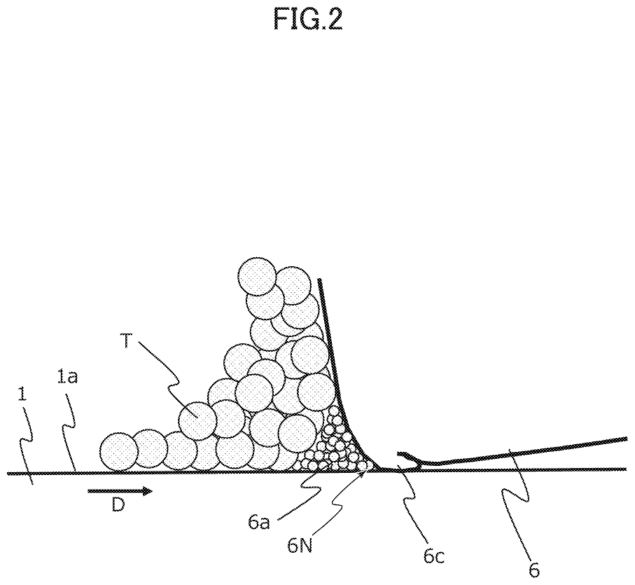

The cleaning blade 6 includes a rubber blade formed of an elastic material, and a support member such as a sheet metal that supports the rubber blade. The support member is attached to a frame body of the charging/cleaning unit 26. An edge portion 6c, i.e., tip portion, of the cleaning blade 6 forms a blade nip 6N (FIG. 2) serving as a contact portion where the cleaning blade 6 and the surface 1a of the photosensitive drum 1 contact each other. The cleaning blade 6 removes attachments such as transfer residual toner and paper dust from the surface 1a of the photosensitive drum 1 at the blade nip 6N, i.e., contact portion.

The edge portion 6c of the cleaning blade 6 according to the present embodiment is in pressure contact with the surface of the photosensitive drum 1 in a counter direction with respect to a direction of rotation of the photosensitive drum 1 illustrated by arrow D. The counter direction is where a direction of the cleaning blade 6 from a base portion toward a tip is oriented upstream with respect to a direction of movement of the surface 1a of the photosensitive drum 1 at the blade nip 6N.

The charging/cleaning unit 26 includes a removed toner chamber 27a that stores the transfer residual toner removed from the surface 1a of the photosensitive drum 1 by the cleaning blade 6, and a scooping sheet 21 that prevents contents of the removed toner chamber 27a from leaking to the exterior of the cartridge.

The developing apparatus 4 includes a developer frame body 31, i.e., developer container, in which a toner storage chamber 31a, i.e., toner storage portion, storing toner serving as developer is formed, a developing roller 25, a feed roller 34, a developing blade 35, a stirring member 36, and a blowout prevention sheet 20. An opposing portion of the photosensitive drum 1 and the developing roller 25 serves as a developing portion, i.e., developing position. During image formation, the developing roller 25 and the feed roller 34 are each driven to rotate in directions of arrows E and C in the drawing.

The developing roller 25 functions as a developer bearing member that bears toner from the toner storage chamber 31a and supplies the same to the photosensitive drum 1 at the developing portion. The feed roller 34 supplies toner from the toner storage chamber 31a to the developing roller 25. The stirring member 36 includes a stirring shaft 36a that rotates by receiving driving force, and a sheet member 36b that rotates together with the stirring shaft 36a, stirring the toner within the toner storage chamber 31a by the sheet member 36b. The developing blade 35 is disposed to contact the outer circumference surface of the developing roller 25. The developing blade 35 regulates the amount of toner to be supplied to the developing portion, i.e., toner coat thickness, and raises the charged amount of toner via frictional charging by rubbing the toner borne on the developing roller 25. The blowout prevention sheet 20 prevents toner from leaking through a gap formed between the developing roller 25 and the developer frame body 31 arranged at the opening portion of the developer frame body 31.

As illustrated in FIG. 1, the scanner unit 3 is disposed above the process cartridge 70. The scanner unit 3 includes a laser light source, and an optical system such as a polygon mirror that guides the light emitted from the laser light source toward the photosensitive drum 1. Further, an LED exposing device in which LED is used as light source may be adopted as the exposing unit.

The transfer roller 69 is in contact with the photosensitive drum 1. A transfer nip N serving as a transfer portion where a toner image is transferred to the sheet S is formed between the photosensitive drum 1 and the transfer roller 69. The transfer roller 69 is an example of a transfer member forming the transfer portion, and for example, a corona discharge-type transfer unit may be used.

The fixing portion 74 includes a fixing roller 74a serving as a heating member, i.e., fixing member, a halogen lamp 74b serving as a heating unit for heating the fixing roller 74a, and a pressure roller 74c in pressure contact with the fixing roller 74a. A fixing nip is formed between the fixing roller 74a and the pressure roller 74c. The fixing portion 74 may be a film heating-type device in which a tubular film is used as the heating member and a ceramic heater is used as the heating unit disposed in an inner space of the film. The heating unit may be a coil that heats a conducting layer within the heating member by principle of induction heating.

### Image Forming Operation

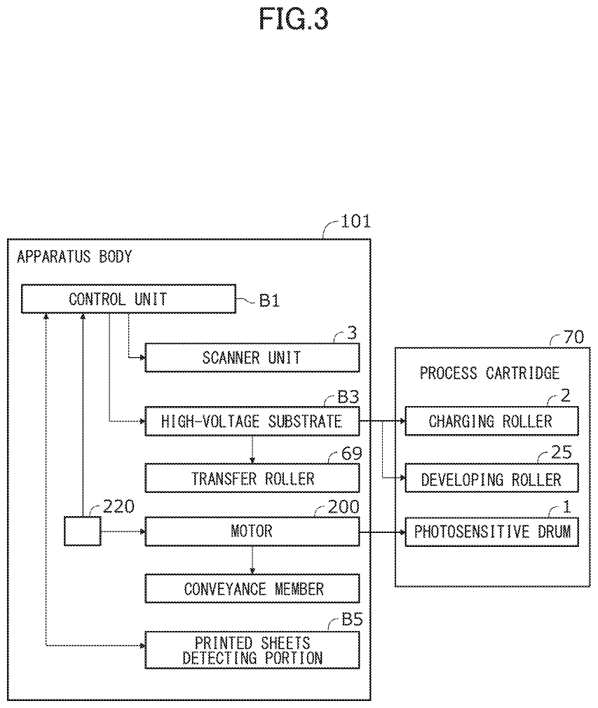

An image forming operation of the image forming apparatus 100 will be described. The image forming operation is a series of operations, also referred to as a printing operation, in which the image forming apparatus 100 forms image on the sheets S while feeding the sheets S one by one. Further, the image forming operation is an operation in which a toner image formed on the surface 1a of the photosensitive drum 1 is transferred to a sheet at the transfer nip N, i.e., transfer portion. A control unit B1 (FIG. 3) of the image forming apparatus 100 executes the image forming operation in a case where an image information is received together with an instruction to execute image forming from a user.

In the image forming operation, the photosensitive drum 1 is driven to rotate at a predetermined peripheral speed, i.e., processing speed, in the arrow D direction of FIG. 1. A predetermined bias voltage, i.e., charging voltage, is applied to the charging roller 2, which charges the surface 1a of the photosensitive drum 1 uniformly to a predetermined polarity and potential. The scanner unit 3 is driven by an image signal, i.e., video signal, generated based on an image information provided when an image forming job is entered, and irradiates laser light to the surface 1a of the photosensitive drum 1. Thereby, the photosensitive drum 1 is exposed, and an electrostatic latent image based on the image information is formed on the surface 1a of the photosensitive drum 1.

The developing apparatus 4 supplies toner to the photosensitive drum 1 by the developing roller 25, and develops the electrostatic latent image into a toner image at the developing portion. At the developing portion, toner is selectively transferred from the developing roller 25 to an image area of the photosensitive drum 1 according to a potential difference between a developing voltage applied to the developing roller 25 and a surface potential of the photosensitive drum 1.

Specifically, a reversal development system is adopted according to the present embodiment. In this case, a surface potential, i.e., dark potential, of the photosensitive drum 1 after being charged by the charging roller 2 is of a same polarity, such as negative polarity, as a normal charge polarity of toner. The scanner unit 3 irradiates an area, i.e., image area, to which a toner image is to be formed on the surface 1a of the photosensitive drum 1 with light, and attenuates the surface potential of the photosensitive drum 1 at the image area. When the developing voltage is set as reference, a potential of the image area, i.e., light potential, has an opposite polarity as a normal charge polarity of toner, and a potential of a non-image area, i.e., dark potential, has the same polarity as the normal charge polarity of toner. Therefore, toner borne on the developing roller 25 and reaching the developing portion is transferred to the image area on the photosensitive drum 1 while toner remains on the developing roller 25 without being transferred to the non-image area. Thereby, a toner image corresponding to the electrostatic latent image is formed on the photosensitive drum 1.

In parallel with the operation described above, a sheet S is fed toward the image forming portion 102 from the cassette sheet feed portion F1 or the manual sheet feed portion F2. The sheet S being fed is subjected to skew correction by the registration roller pair 88, and then conveyed to the transfer nip N. While the sheet S passes through the transfer nip N, toner image is transferred from the photosensitive drum 1 to the sheet S by application of transfer voltage to the transfer roller 69.

The sheet S having passed through the transfer nip Nis subjected to an image fixing process at the fixing portion 74. The fixing portion 74 heats and presses the toner image on the sheet S while nipping and conveying the sheet S by the fixing nip. The sheet S having passed through the fixing portion 74 is discharged to an exterior of the apparatus body 101 by the sheet discharge roller pair, and supported on a sheet discharge tray disposed on an upper surface of the apparatus body 101.

### Sheet Conveyance Path

A configuration of the cassette sheet feed portion F1 and the manual sheet feed portion F2 provided in the image forming apparatus 100 of the first embodiment, and a sheet conveyance path from the cassette sheet feed portion F1 or the manual sheet feed portion F2 to the transfer nip N will be described.

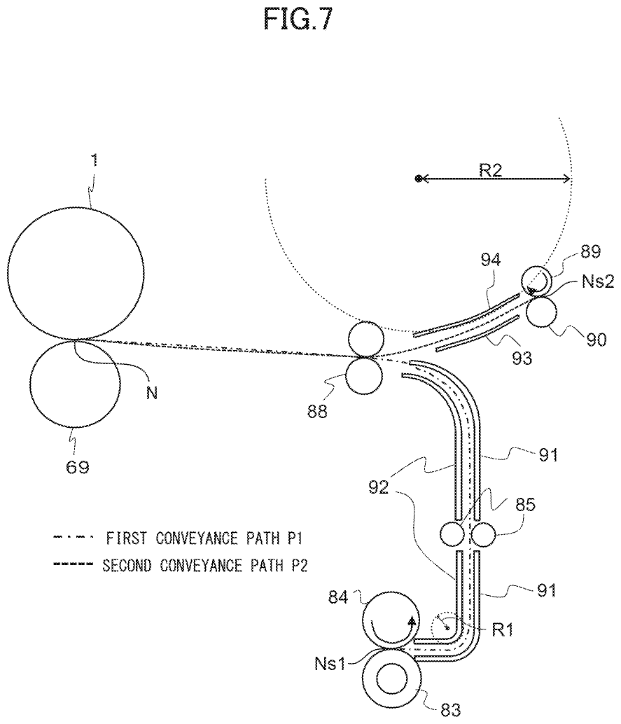

As illustrated in FIG. 1A, the cassette sheet feed portion F1 includes a sheet cassette 80, a pickup roller 82, a feed roller 84, a separation roller 83, conveyance guides 91 and 92 (FIG. 7), and a relay roller pair 85.

The sheet cassette 80 is an example of a first supporting portion on which the sheet S used as the recording material is supported. Further, the sheet cassette 80 is a sheet storage portion, i.e., storage or sheet supporting portion, in which the sheet S is stacked and stored. The sheet S supported on the sheet cassette 80 is conveyed to the transfer nip N via a conveyance path, i.e., first conveyance path P1, described later. The sheet cassette 80 is attached to a lower portion of the apparatus body 101 so as to be drawable therefrom.

The pickup roller 82 is arranged above the sheet cassette 80, and sends out the sheet S from the sheet cassette 80 toward a first feeding direction D1 by rotating in contact with an uppermost sheet S of a sheet bundle in the sheet cassette 80. The feed roller 84 is disposed downstream of the pickup roller 82 in the first feeding direction D1 and conveys the sheet S further. The separation roller 83 comes into pressure contact with the feed roller 84, and applies a frictional force in a direction opposite to the first feeding direction D1 to the sheet S at a separation nip Ns1 formed between the feed roller 84 and the separation roller 83. Thereby, the separation roller 83 prevents the sheet S other than the uppermost sheet S in contact with the feed roller 84 from passing through the separation nip Ns1 in a case where a plurality of sheets S are sent out by the pickup roller 82.

The separation roller 83 may be a roller that is supported via a torque limiter to a non-rotatable fixing shaft supported on a frame body of the apparatus body 101. The separation roller 83 may be a roller, i.e., retard roller, to which a driving force in a direction opposite to a direction co-rotating with the feed roller 84 is entered via a torque limiter from the motor disposed in the apparatus body 101. Further, the separation roller 83 is an example of a separation member that applies frictional force to the sheet S to separate the sheet S, and for example, a pad-shaped elastic member that comes into contact with the feed roller 84 may be used as the separation member.

The conveyance guides 91 and 92 form at least a portion of a conveyance path, i.e., the first conveyance path P1, through which the sheet S conveyed from the sheet cassette 80 toward the transfer nip N passes. The relay roller pair 85 is disposed between the feed roller 84 and the registration roller pair 88 in the first conveyance path P1, and conveys the sheet S having passed through the separation nip Ns1 toward the registration roller pair 88. If the distance from the feed roller 84 to the registration roller pair 88 is short, the relay roller pair 85 may be omitted.

The manual sheet feed portion F2 includes a manual feed tray 81, a feed roller 89, a separation roller 90, and conveyance guides 93 and 94 (FIG. 7).

The manual feed tray 81 is a second supporting portion on which the sheets S used as the recording material are supported, and it is an example of the second supporting portion on which the sheets S conveyed via a conveyance path, i.e., second conveyance path P2, that differs from the conveyance path, i.e., the first conveyance path P1, of the sheet S supported on the first supporting portion are supported. Further, the manual feed tray 81 is a sheet stacking portion or sheet supporting portion on which the sheet S is supported. The manual feed tray 81 is disposed to protrude to the exterior of the apparatus body 101. The user can access the manual feed tray 81 from the exterior of the image forming apparatus 100 and set the sheets S on the manual feed tray 81.

The feed roller 89 is disposed above the manual feed tray 81, and sends out the sheet S from the manual feed tray 81 toward a second feeding direction D2 by rotating in contact with an uppermost sheet S on the manual feed tray 81. The separation roller 90 comes into pressure contact with the feed roller 89, and applies a frictional force in a direction opposite to the second feeding direction D2 to the sheet S at a separation nip Ns2 formed between the feed roller 89 and the separation roller 90. Thereby, the separation roller 90 prevents the sheet S other than the uppermost sheet S in contact with the feed roller 89 from passing through the separation nip Ns2.

The separation roller 90 may be a roller that is supported via a torque limiter on the fixing shaft, or a roller, i.e., retard roller, to which a driving force in a direction opposite to the direction co-rotating with the feed roller 84 is entered via the torque limiter. Further, the separation roller 90 is an example of a separation member that applies frictional force to the sheet S to separate the sheet S, and for example, a pad-shaped elastic member that comes into contact with the feed roller 89 may be used as the separation member.

The conveyance guides 93 and 94 form at least a portion of a conveyance path, i.e., the second conveyance path P2, through which the sheet S conveyed from the manual feed tray 81 toward the transfer nip N passes. If the distance from the feed roller 89 to the registration roller pair 88 is long, there may be one or more relay roller pairs additionally disposed between the feed roller 89 and the registration roller pair 88.

A direction of movement of the sheet S at the transfer nip N is referred to as a transfer conveyance direction Dt. In this case, a sheet conveyance direction from the sheet cassette 80, i.e., the first feeding direction D1, and a sheet conveyance direction from the manual feed tray 81, i.e., the second feeding direction D2, are oriented toward opposite directions with respect to directions parallel to the transfer conveyance direction Dt. That is, a component of the first feeding direction D1 parallel to the transfer conveyance direction Dt is oriented opposite to the transfer conveyance direction Dt, and a component of the second feeding direction D2 parallel to the transfer conveyance direction Dt is oriented in the same direction as the transfer conveyance direction Dt.

In other words, the feed roller 84 of the cassette sheet feed portion F1 is an example of a first feeding member that feeds the sheets supported on the first supporting portion toward an opposite side as the direction of movement of the sheet at the transfer portion in a direction parallel to the above-mentioned direction of movement. The feed roller 89 of the manual sheet feed portion F2 is an example of a second feeding member that feeds the sheets supported on the second supporting portion toward a same direction as the above-mentioned direction of movement in a direction parallel to the above-mentioned direction of movement. Therefore, the sheet S fed from the first feeding member is turned toward the transfer conveyance direction Dt in the first conveyance path, during which state paper dust tends to occur.

In the present embodiment, the conveyance path, i.e., the first conveyance path P1, from the sheet cassette 80 toward the transfer nip N is curved approximately in a U shape. At least a portion of the first conveyance path P1 is curved such that a conveyance direction of the sheet S fed from the sheet cassette 80 toward the first feeding direction D1 is oriented toward an opposite side as the first feeding direction D1 before the sheet S reaches the transfer nip N. In other words, the first conveyance path P1 is curved such that the sheet fed by the feed roller 84, i.e., first feeding member, toward an opposite side as the transfer conveyance direction Dt, i.e., direction of movement, is guided toward a direction corresponding to the transfer conveyance direction Dt, i.e., direction of movement.

More specifically, the conveyance guides 91 and 92 according to the present embodiment form a conveyance path that is curved approximately in a U shape between the feed roller 84 and the registration roller pair 88. That is, the first conveyance path P1 is formed to receive the sheet S fed toward the first feeding direction D1 toward one side in the horizontal direction, i.e., right side in the drawing of FIG. 1A, and to send out the sheet S toward the other side in the horizontal direction, i.e., left side in the drawing. The registration roller pair 88 conveys the sheet S in the direction along the transfer conveyance direction Dt.

### Control Configuration

A control configuration of the image forming apparatus 100 will be described below. FIG. 3 is a block diagram illustrating a hardware configuration of the image forming apparatus 100 according to the first embodiment.

The control unit B1, a high-voltage substrate B3, a printed sheets detecting portion B5, a motor control unit 220, and a motor 200 are disposed in the apparatus body 101 of the image forming apparatus 100. The control unit B1 sends instructions to and controls the operations of the scanner unit 3, the high-voltage substrate B3, and various loads such as the motor. The control unit B1 is an example of a controller or a control circuit for controlling the operation of the image forming apparatus 100. The control unit B1 executes the aforementioned image forming operation or a toner purge operation, i.e., toner supplying operation, described later. The control unit B1 includes a CPU that executes programs for controlling the image forming apparatus 100, and a storage unit, i.e., memory, that stores programs and data and also provides a workplace for the CPU.

The high-voltage substrate B3 includes a voltage generation circuit that generates voltages as an AC or DC high voltage from an AC voltage supplied from a commercial power supply outside the apparatus. Various voltages include a bias voltage, i.e., charging voltage, applied to the charging roller 2, a bias voltage, i.e., developing voltage, applied to the developing roller 25, and a bias voltage, i.e., transfer voltage, applied to the transfer roller 69. Electric components such as the charging roller 2 and the developing roller 25 which are targets to which voltage is applied in the process cartridge 70 are electrically connected to the high-voltage substrate B3 via a contact portion where a terminal, i.e., contact, of the process cartridge 70 and a terminal, i.e., contact, of the apparatus body 101 contact each other.

The printed sheets detecting portion B5 can count an accumulated number of times the image forming operation has been executed by the image forming apparatus 100, i.e., accumulated number of printed sheets. The printed sheets detecting portion B5 may be implemented as a dedicated circuit independent from the control unit B1, or may be realized as a function of a program executed by the CPU of the control unit B1.

The motor 200 is a driving source that drives at least one conveyance member related to the conveyance of the sheet S. The motor 200 of the present embodiment drives the pickup roller 82, the feed rollers 84 and 89, and the registration roller pair 88 to rotate. The pickup roller 82, the feed rollers 84 and 89, and the registration roller pair 88 are each an example of a conveyance member that conveys the sheet S. The motor 200 can drive other driving targets. For example, the motor 200 may drive the fixing portion 74, and the photosensitive drum 1, the charging roller 2, the developing roller 25, and the stirring member 36 of the process cartridge 70.

### Lubricating Layer

Next, a lubricating layer formed at a contact portion between the cleaning blade 6 and the photosensitive drum 1 will be described. FIG. 2 is a schematic view illustrating an enlarged cross-section of the blade nip 6N, which is a contact portion where the edge portion 6c of the cleaning blade 6 and a surface, i.e., outer circumference surface, of the photosensitive drum 1 come into contact.

At the blade nip 6N, the edge portion 6c of the cleaning blade 6 receives frictional force from the rotating photosensitive drum 1. If the frictional force is large, turning-up or chipping of the cleaning blade 6, i.e., turning-up or chipping of the rubber blade, occurs, and toner may pass through the blade nip 6N.

An assembly in which external additives contained in toner are accumulated, hereinafter referred to as a lubricating layer 6a, is formed at the blade nip 6N. The lubricating layer 6a is formed on an upstream side in a direction of rotation of the photosensitive drum 1, i.e., arrow direction in the drawing, with respect to a contact area of the cleaning blade 6 and the photosensitive drum 1 at the blade nip 6N. The lubricating layer 6a includes fine particles contained as external additives in toner. Examples of external additives that form the lubricating layer 6a are inorganic silica particles and organic silicon polymer particles, but are not limited thereto. In the present embodiment, the lubricating layer 6a is described as being formed mainly of fine particles of external additives having a smaller mean particle size than toner particles Tn, but substances other than external additive, such as toner particles Tn accumulated at the blade nip 6N, may also be included in the lubricating layer 6a.

The presence of the lubricating layer 6a improves the sliding performance of the cleaning blade 6 on the surface 1a of the photosensitive drum 1. Therefore, the lubricating layer 6a may reduce the turning-up or chipping of the cleaning blade 6 and reduce the passing through of toner. The lubricating layer 6a may be referred to as a blocking layer, i.e., barrier layer, that blocks toner from passing through.

As described, the lubricating layer 6a contributes to maintaining and improving the cleaning performance. When the lubricating layer 6a runs out, the turning-up or chipping of the cleaning blade 6 and the passing through of toner caused thereby may occur. Toner having passed through the blade nip 6N may be accumulated on the charging roller 2 and cause charging failures.

### Toner Purge Operation

A toner purge operation of the image forming apparatus 100 will be described. Toner purge operation is an operation, i.e., toner supplying operation, in which a predetermined toner image, i.e., toner pattern, formed on the surface 1a of the photosensitive drum 1 passes through the transfer portion and toner is supplied to the blade nip 6N, which is the contact portion of the cleaning blade 6 and the photosensitive drum 1. By executing the toner purge operation when no image is being formed, the control unit B1 can supply toner to the blade nip 6N and prevent depletion of the lubricating layer 6a.

In the toner purge operation, similar to a normal image forming operation, after the surface of the rotating photosensitive drum 1 is charged by the charging roller 2, the photosensitive drum 1 is exposed by the scanner unit 3, and a latent image is formed on the surface of the photosensitive drum 1. The latent image is developed by having toner supplied from the developing roller 25, and a toner image of a predetermined pattern is formed on the surface of the photosensitive drum 1. The toner image of a predetermined pattern passes through the transfer nip N without being transferred to the sheet S, and reaches the blade nip 6N.

In the toner purge operation, the predetermined toner image formed of a predetermined pattern, hereinafter referred to as a toner pattern, is formed to have a density and shape set in advance, unlike the latent image formed in the image forming operation based on the image information. The information designating the density and shape of the toner pattern may set to be stored in advance in the storage unit within the control unit B1.

The toner pattern according to the present embodiment is a uniform toner image having a highest density formable by the image forming portion 102, i.e., solid image. Further, the toner pattern according to the present embodiment has a rectangular shape extending in a rotational axis direction X of the photosensitive drum 1, i.e., main scanning direction during forming of image. That is, the toner pattern according to the present embodiment has a rectangular shape extending in the rotational axis direction X of the photosensitive drum 1 in a state where the surface 1a of the photosensitive drum 1 is developed in a plane.

A length of the toner pattern in the sub-scanning direction of the photosensitive drum 1, i.e., circumference surface direction of the photosensitive drum 1, is referred to as a width of the toner pattern. Further, a total amount of toner of the toner pattern formed on the photosensitive drum 1 by a toner purge operation is referred to as a “toner purge amount”.

When the toner image passes through the transfer nip N in the toner purge operation, a bias voltage of an opposite polarity as that of the transfer voltage during forming of image is applied to the transfer roller 69. For example, in a case where a normal charge polarity of toner is a negative polarity, the transfer voltage during forming of image has a positive polarity, and the bias voltage applied to the transfer roller 69 in the toner purge operation has a negative polarity. Therefore, the toner pattern formed of toner charged to negative polarity passes through the transfer nip N without being transferred to the transfer roller 69 and reaches the blade nip 6N.

The expression “when image is not formed” basically refers to a timing other than during execution of image forming operation. For example, in a case where the control unit B1 (FIG. 3) of the image forming apparatus 100 receives an image forming instruction from the user, the control unit B1 executes an image forming job, hereinafter sometimes simply referred to as job, including the aforementioned image forming operation. The image forming job is a series of tasks including an image forming operation executed repeatedly to the number of sheets S designated by the user, a pre-rotation operation, which is a preparation operation of the image forming operation, and a post-rotation operation, which is an adjustment operation executed after the image forming operation. In the post-rotation operation, even after the last image forming operation during a job has ended, the rotation of the photosensitive drum 1 is continued for a predetermined period of time, while adjustments such as a shutdown processing of various bias voltages, i.e., stopping of voltage output, and cooling of the fixing portion 74 are performed.

The expression “when image is not formed” may include during execution of the post-rotation operation, during execution of the pre-rotation operation, and a period from execution of the previous image forming operation to the execution of a subsequent image forming operation within one job, i.e., so-called sheet interval. In the present embodiment, the toner purge operation is executed during execution of the post-rotation operation, i.e., during post-rotation. In other words, upon receiving an image forming job from the user, the control unit B1 executes the toner supplying operation during a period of time after the transfer of the toner image has been performed to all the number of sheets designated by the user and before the rotational driving of the photosensitive drum 1 is stopped.

In the image forming apparatus 100, there may be a case where a portion of the image forming operation and a portion of the operation when image is not formed overlap on a timeline. Therefore, “when image is not formed” is described based on a timing at which a point being focused on the surface 1a of the photosensitive drum 1 passes through the transfer nip N. For example, a case is assumed where the last sheet S of a job has not yet passed through the transfer nip N at a point of time when the scanner unit 3 started exposing the photosensitive drum 1 to form a toner pattern for the toner purge operation. Even in such a case, if exposure is started at a timing at which the leading edge of the toner pattern reaches the transfer nip N after the last sheet S has passed through the transfer nip N, it can be stated that the toner purge operation is executed when image is not formed, i.e., during post-rotation.

### Influence of Paper Dust

Next, the depletion and reformation of the lubricating layer 6a, and influence of paper dust will be described. Along with the rotation of the photosensitive drum 1, external additives leak through the blade nip 6N little by little, such that the lubricating layer 6a is gradually reduced during execution of the image forming operation. If the image forming operation is executed in a state where the lubricating layer 6a is reduced, turning-up or chipping of the cleaning blade 6 may occur, and passing through of toner may occur. For example, after the photosensitive drum 1 has been stopped in a state where the lubricating layer 6a is reduced by the image forming operation performed during the previous job, if a subsequent image forming job is entered and the rotation of the photosensitive drum 1 is started, turning-up or chipping of the cleaning blade 6 tends to occur. A state in which the turning-up or chipping of the cleaning blade 6 tends to occur by the reduction of the lubricating layer 6a may be referred to as a state in which the lubricating layer 6a has been depleted.

By executing the toner purge operation when image is not formed, toner and external additives may be supplied to the blade nip 6N, and the lubricating layer 6a may be reformed. Thereby, the passing through of toner may be suppressed, and a stable cleaning performance may be maintained for a long period of time. Specifically, by executing the toner purge operation during post-rotation, a state in which the lubricating layer 6a is depleted at the time the driving of the photosensitive drum 1 is started after a subsequent image forming job has been entered may be prevented, such that the passing through of toner may be suppressed more effectively.

However, if the cleaning performance is maintained within a permissible range, it may be preferable that the amount of toner consumed by the toner purge operation is as little as possible. As the amount of toner consumed by the toner purge operation increases, the ratio of toner among the toner stored in the toner storage chamber 31a that is consumed without being used for image formation also increases. Therefore, as the amount of toner consumed by the toner purge operation increases, the accumulated number of sheets on which image can be output by the image forming apparatus 100, i.e., printable number of sheets, from the time the process cartridge 70 has been exchanged to the depletion of toner within the process cartridge 70 decreases. Further, even if an excessive amount of toner has been supplied during the toner purge operation, there is a limit in the amount of external additives to be maintained at the blade nip 6N as the lubricating layer 6a, such that the period of time until the lubricating layer 6a is depleted will not be extended.

### Deterioration of Cleaning Performance by Paper Dust

As described above, when forming images, the lubricating layer 6a is gradually reduced, but specifically, the depletion of the lubricating layer 6a may be advanced by the influence of paper dust. Paper dust is foreign matter that is generated from the sheets S used as recording material and mainly attached to the photosensitive drum 1 at the transfer nip N. Paper dust includes paper fiber and/or filler.

The present inventors have discovered that even if the toner purge operation is executed when image is not formed, excess or deficiency of toner supplied to the blade nip 6N, which is the contact portion of the cleaning member and the photosensitive drum, may occur, depending on the condition of the image forming operation, hereinafter referred to as image forming condition. Further, the present inventors have also discovered that the excess or deficiency of toner supplied to the contact portion, i.e., the blade nip 6N, may cause decrease of the printable number of sheets due to excessive toner consumption, or deterioration of cleaning performance by depletion of the lubricating layer.

More specifically, if paper dust attached to the photosensitive drum 1 enters the blade nip 6N, the reduction of the lubricating layer 6a advances compared to a state where paper dust has not entered thereto. It is considered that a portion of the external additives of the lubricating layer 6a passes through the blade nip 6N by being pushed by the paper dust that moves in the direction of rotation of the photosensitive drum 1 together with the surface 1a of the photosensitive drum 1. Therefore, when the image forming operation is executed under an image forming condition where a large amount of paper dust is generated, the pace of reduction of the lubricating layer 6a is advanced even if the number of image forming operations is the same compared to a case where the image forming operation is executed under an image forming condition with less paper dust.

The image forming condition may include designation of cassette or tray serving as a supply source of the sheet S used for image formation, attributes of the sheet S such as material, size, and grammage, designation of simplex or duplex printing, and an average image cover of the image being output.

Control of Toner Purge Amount based on Motor Load

Next, a prediction of amount of generation of paper dust based on a motor load during image formation, and a control of toner purge amount based on the motor load will be described.

At first, a method for detecting a motor load, which is a load torque of the motor 200, will be described. The load torque of the motor 200 is the torque acting on an output shaft of the motor when performing image formation. This load torque contains a component caused by frictional resistance that the sheet S receives from the conveyance guide along with the conveyance of the sheet during image formation. Further, the load torque of the motor 200 may also be referred to as an output torque of the motor 200 or a generation torque of the motor 200 during image formation.

The load torque of the motor 200 may be detected based on a current value, i.e., coil current, supplied to the coil of the motor 200. A method for detecting a load torque will be described below, taking a case where a brushless motor is used as the motor 200 as an example.

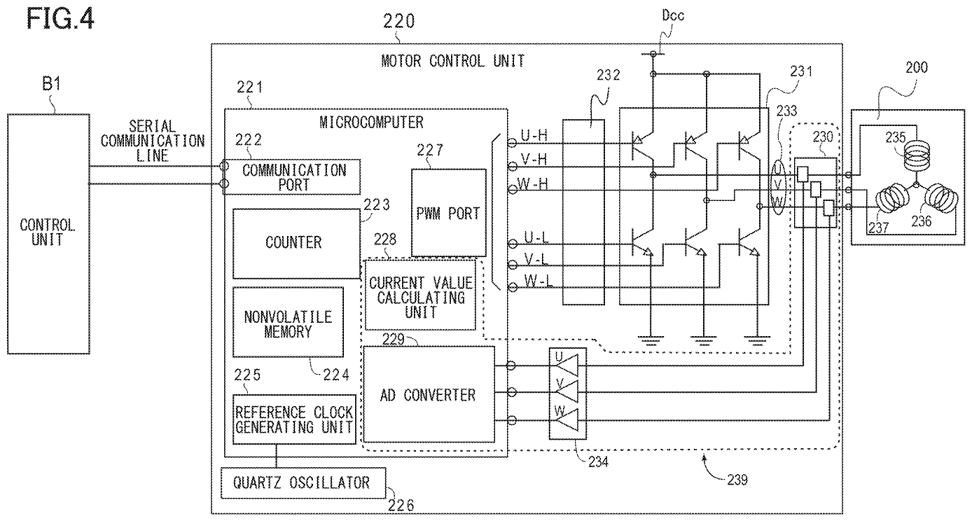

At first, a structure of the motor 200 will be described with reference to FIG. 4. FIG. 4 is a schematic view illustrating a structure of the motor 200, i.e., brushless motor, according to the present embodiment. The motor 200 includes a six-slot stator 240, and a four-pole rotor 241. The stator 240 includes, as a plurality of coils, a U-phase coil 235, a V-phase coil 236, and a W-phase coil 237. The rotor 241 is formed of a permanent magnet, and includes two sets of N/S poles. The U-phase, V-phase, and W-phase coils 235, 236, and 237 are connected to the motor control unit 220 described below.

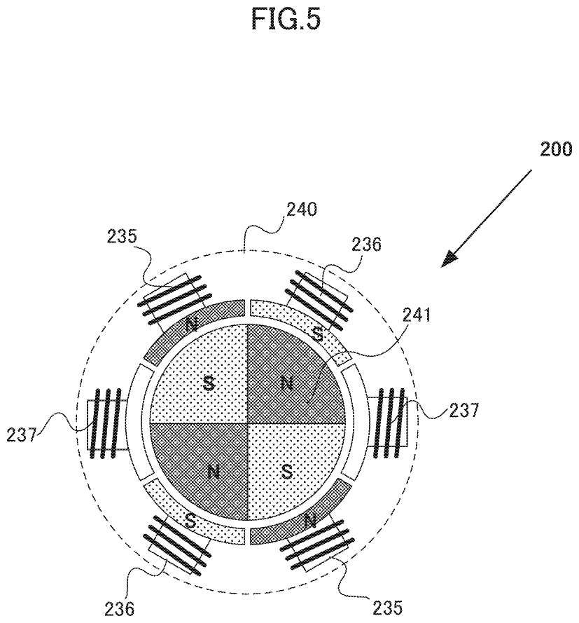

Next, a detection mechanism of a current value supplied to the motor control unit 220 and the motor 200 will be described with reference to FIG. 5. The motor control unit 220 is a motor driving circuit, i.e., motor driver, for driving the motor 200. The motor control unit 220 is connected via a serial communication line with the control unit B1 described above, which is the main control unit of the image forming apparatus 100, and operates based on an instruction from the control unit B1.

The motor control unit 220 includes an arithmetic processing circuit using a microcomputer 221. The microcomputer 221 includes a communication port 222, an AD converter 229, a counter 223, a nonvolatile memory 224, a reference clock generating unit 225, a PWM port 227, and a current value calculating unit 228. The counter 223 performs a counting operation according to a reference clock that the reference clock generating unit 225 has generated using a quartz oscillator 226. Measurement of cycle of pulses being entered or generation of PWM signals are performed based on a count value of the counter 223. The PWM port 227 includes six terminals, which are connected to three signal wires on a high side (U-H, V-H, and W-H) and three signal wires on a low side (U-L, V-L, and W-L). The microcomputer 221 outputs PWM signals to the respective signal wires via the PWM port 227.

Further, the motor control unit 220 includes a three-phase inverter 231 including three switching elements on the high side and three switching elements on the low side. An FET or a bipolar transistor may be used as the switching element. In the case of FET, the gates of the respective switching elements are connected via a gate driver 232 to the PWM port 227, either one of a drain/source is connected to a power supply circuit Dcc, and the other one of the drain/source is grounded. The power supply circuit Dcc generates a DC voltage from an AC voltage supplied from a commercial power supply outside the image forming apparatus 100. The gate driver 232 controls the ON/OFF of the switching elements according to the PWM signals output from the PWM port 227. The respective switching elements are set to the ON state when the value of the PWM signal is H, and set to the OFF state when the value is L.

A U/V/W phase output 233 of the inverter 231 is connected to coils 235, 236, and 237 of the motor, and the U/V/W phase output 233 controls coil currents supplied to the respective coils 235, 236, and 237.

The coil currents of the respective coils 235, 236, and 237 are detected by a current detecting unit 239. The current detecting unit 239 is an example of a detecting unit for detecting information related to a load applied to the motor 200. The current detecting unit 239 of the present embodiment detects a coil current serving as information related to the load applied to the motor 200.

The current detecting unit 239 includes a current sensor 230, an amplifier unit 234, the AD converter 229, and the current value calculating unit 228. At first, the coil currents of the respective coils 235, 236, and 237 are converted into a voltage by the current sensor 230. The voltage is amplified and applied of offset voltage at the amplifier unit 234, and entered to the AD converter 229 of the microcomputer 221. For example, it is assumed that the current sensor 230 outputs a voltage of 0.01 V per 1A, an amplification factor at the amplifier unit 234 is 10 times, and the offset voltage applied thereto is 1.6 V. In this case, the output voltage of the amplifier unit 234 in a state where a current of −10 A to +10 A is supplied is 0.6 to 2.6 V. The AD converter 229 converts a voltage of 0 to 3 V into a digital value of 0 to 4095, and outputs the same. Hereafter, a voltage value serving as a digital value subjected to A/D conversion by the AD converter 229 is referred to as an AD value. The AD value of a state where a current of −10 A to +10 A is supplied is approximately 819 to 3549. The positive/negative of the current is referred to as positive when the current is flown from the three-phase inverter 231 to the motor 200.

The current value calculating unit 228 carries out a predetermined operation to the AD value, and calculates the current value. For example, the current value is obtained by subtracting an offset value from the AD value, then multiplying the value with a predetermined coefficient. The offset value is an AD value corresponding to the offset voltage 1.6 V, which is approximately 2184, and the coefficient is approximately 0.00733.

The offset value may use a value stored in the memory obtained by reading the AD value when no coil current is supplied. The coefficient may use a value stored in advance as a standard coefficient in the nonvolatile memory 224.

As described, by controlling the three-phase inverter 231 via the gate driver 232, the microcomputer 221 can supply currents to the coils 235, 236, and 237 of the motor 200. The microcomputer 221 detects a coil current by the current detecting unit 239 including the current sensor 230, the amplifier unit 234, and the AD converter 229, and calculates a rotor position and speed of the motor 200 based on the detected coil current. Thereby, the microcomputer 221 can control the rotation of the motor 200.

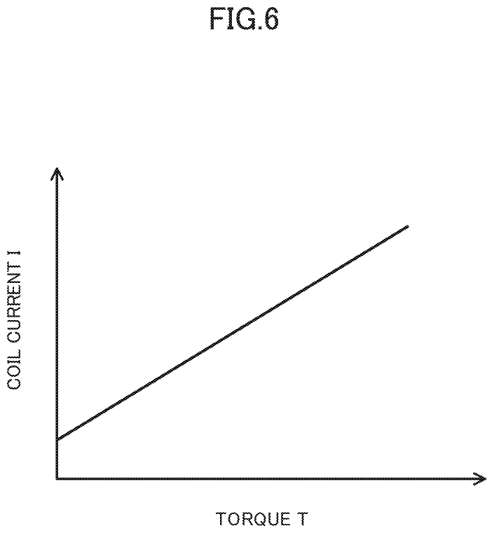

FIG. 6 illustrates a relationship between a load torque T of the motor 200 and a coil current I supplied to the motor 200, i.e., torque-current characteristics, or T-I characteristics. There is a correlation between the load torque T and the coil current I of the motor 200, such that the load torque T of the motor 200 during image formation may be calculated based on the T-I characteristics of the motor 200 disposed in the image forming apparatus 100 and the value of the coil current I detected during image formation.

More specifically, information regarding the T-I characteristics of the motor 200 disposed in the image forming apparatus 100 is stored in advance in a nonvolatile memory of the control unit B1. The control unit B1 acquires the value of the coil current I detected during image formation from the microcomputer 221, and calculates the load torque T using the information in the nonvolatile memory. Information regarding the T-I characteristics of the motor 200 may be a coefficient of a function representing the load torque T with the coil current I set as a variable, or it may be a table representing the corresponding relationship of the value of the coil current I and the value of the load torque T.

Rotational control of the motor 200 performed by the microcomputer 221 may be a so-called vector control, also referred to as field directivity control. In vector control, the U/V/W phase output 233 is converted by vector conversion into a dq coordinate system and separated into a torque component, i.e., q-axis current Iq, and a magnetic flux component, i.e., d-axis current Id, wherein the two components are controlled independently. The control of the U/V/W phase output 233 is performed by subjecting a value obtained by applying feedback control, such as PI control, to each of the q-axis current Iq and the d-axis current Id to inverse conversion to a U/V/W three-phase voltage value.

According to the above description, the load torque T is calculated based on the coil current I for convenience, but the load torque T may also be calculated based on the q-axis current Iq. For example, the control unit B1 may acquire a value of the q-axis current Iq during image formation from the microcomputer 221, and calculate the load torque T based on a T-I characteristics (illustrated in FIG. 6 in which Iq is shown on the vertical axis) prepared in advance as a specification of the motor 200.

The motor 200 may be a so-called brushless DC motor that is driven, for example, by 120-degree conduction control. The 120-degree conduction control refers to a control method in which the U/V/W phase output 233 is a rectangular wave output according to which a direction of composite magnetic flux generated by the coils 235, 236, and 237 switches each time the rotor 241 rotates for 60 degrees. Similarly, according to this case, the load torque of the motor 200 during image formation may be calculated based on the coil current and the T-I characteristics of the motor 200.

Further, a known DC motor or an AC motor may be used as the motor 200.

### Change in Motor Load by Different Conveyance Paths

Next, a change of motor load according to the difference in conveyance paths is described with reference to FIG. 7. FIG. 7 is a schematic diagram illustrating a portion of the image forming apparatus 100 according to the present embodiment.

A path through which the sheet S is conveyed from the sheet cassette 80 toward the transfer nip N is referred to as the first conveyance path P1 or a cassette sheet feed path. A path through which the sheet S is conveyed from the manual feed tray 81 toward the transfer nip N is referred to as the second conveyance path P2 or a manual sheet feed path. The first conveyance path P1 and the second conveyance path P2 may be partially overlapped. In the present embodiment, the first conveyance path P1 and the second conveyance path P2 are overlapped in the section from the registration roller pair 88 to the transfer nip N.

The first conveyance path P1, i.e., cassette sheet feed path, is curved relatively steeply. According to the illustrated configuration example, at least in the section between the feed roller 84 and the relay roller pair 85, the conveyance path formed between the conveyance guides 91 and 92 is curved most steeply. Meanwhile, the second conveyance path P2, i.e. manual sheet feed path, is either straight, or curved gently compared to the first conveyance path P1.

In a state where the sheet S is conveyed on the curved conveyance path, for example, a tip portion of the sheet S, that is, downstream edge of the sheet in the sheet conveyance direction, rubs against the surface of the conveyance guide and receives frictional force. The conveyance guides 91 to 94 are formed of a resin material such as a polycarbonate resin, an ABS resin, or a PC+ABS resin. In the present embodiment, PC+ABS resin is used. The stronger the sheet S rubs against the conveyance guide, the more the smoothness of the sheet surface is lost at the rubbed portion, and a state occurs where fiber or filler is easily separated from the surface of the sheet S. Therefore, the amount of generation of paper dust increases as the sheet S is rubbed more strongly against the conveyance guide.

Further, the frictional force that the sheet S receives from the roller becomes stronger as the speed difference between a speed of movement of the sheet S and a circumference surface speed of the roller coming into contact with the sheet S, such as the feed rollers 84 and 89 or the registration roller pair, increases. In the case where the frictional force that the sheet S receives from the roller is strong, the amount of generation of paper dust also tends to increase.

Further, the frictional charging of the sheet S occurs more easily by being rubbed against the conveyance guide or the rollers as the frictional force that the sheet S receives from the conveyance guide or the rollers increases. If the sheet S passes through the transfer nip N in a state where the charged amount of the sheet S is high, a part of the paper dust transfers to the photosensitive drum 1 electrostatically by a potential difference between the transfer roller 69 to which the transfer voltage is applied and the surface potential of the photosensitive drum 1.

When the sheet S passes through two conveyance paths having different radii of curvature at the same speed, the force applied to the sheet S per unit time is approximately inversely proportional to the radius of curvature. Therefore, the frictional force between the sheet S and the conveyance member becomes greater as the radius of curvature of the conveyance path reduces, and the load torque of the motor 200 during conveyance increases. By the increase of frictional force, the amount of paper dust transferred to the photosensitive drum 1 is also increased.

In a state where the photosensitive drum 1 is viewed in the rotational axis direction X, a minimum value of a radius of curvature of a guide surface, i.e., surface facing the conveyance guide positioned on the outer side of a curved portion, of the conveyance guide positioned on an inner side of the curved portion of the first conveyance path P1 is defined as a minimum radius of curvature R1 of the first conveyance path P1. Similarly, in a state where the photosensitive drum 1 is viewed in the rotational axis direction X, a minimum value of a radius of curvature of a guide surface, i.e., surface facing the conveyance guide positioned on the outer side of a curved portion, of the conveyance guide positioned on an inner side of the curved portion of the second conveyance path P2 is defined as a minimum radius of curvature R2 of the second conveyance path P2. The minimum radius of curvature R1 represents a degree of curvature of the most steeply curved portion of the first conveyance path P1, and the minimum radius of curvature R2 represents a degree of curvature of the most steeply curved portion of the second conveyance path P2.

According to the present embodiment, a conveyance guide 92, i.e., first conveyance guide, is positioned on an inner side of the curved portion of the first conveyance path P1. The minimum radius of curvature R1 of the first conveyance path P1 is a minimum value of a radius of curvature of a surface, i.e., guide surface that guides the sheet S, of the conveyance guide 92, i.e., first conveyance guide, when the photosensitive drum 1 is viewed in the rotational axis direction X. Further according to the present embodiment, a conveyance guide 94, i.e., second conveyance guide, is positioned on an inner side of the curved portion of the second conveyance path P2. The minimum radius of curvature R2 of the second conveyance path P2 is a minimum value of a radius of curvature of a surface, i.e., guide surface that guides the sheet S, of the conveyance guide 94, i.e., second conveyance guide, when the photosensitive drum 1 is viewed in the rotational axis direction X.

According to the present embodiment, the minimum radius of curvature R1 of the first conveyance path P1 is smaller than the minimum radius of curvature R2 of the second conveyance path P2, i.e., R1<R2. That is, a portion of the first conveyance path P1 curved most steeply is curved steeper than the portion of the second conveyance path P2 curved most steeply. The minimum radius of curvature R1 is 50 mm, and R2 is 300 mm, for example.

From the relationship of R1<R2, according to the present embodiment, the frictional resistance that the sheet S conveyed via the first conveyance path P1 receives from the conveyance guide is greater than the frictional resistance that the sheet S conveyed via the second conveyance path P2 receives from the conveyance guide. That is, according to the present embodiment, the load torque of the motor 200 in a state where the sheet S is conveyed via the first conveyance path P1 tends to be greater than the load torque of the motor 200 in a state where the sheet S is conveyed via the second conveyance path P2.

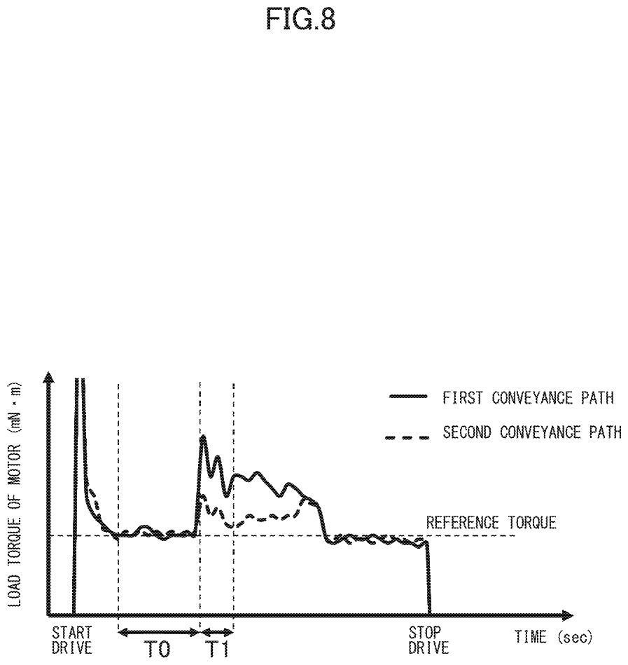

A method for calculating an amount of increase of motor load accompanying the sheet conveyance during image formation, hereinafter referred to as a conveyance load torque, will be described with reference to FIG. 8. FIG. 8 illustrates a transition of load torque of the motor 200 during image formation. The load torque rises steeply when the motor 200 is started, i.e., when the motor starts to rotate from the stationary state, is reduced thereafter, and enters a stable state. A period during which the motor torque is stable is referred to as TO, and an average value of the motor torque during the above-mentioned period is referred to as a reference torque. In the present embodiment, in a state where a feed start timing of the sheet S is set as reference, the period from before 500 ms to the feed start timing is referred to as T0. An average value of load torque of the motor 200 during period T0 is referred to as a reference torque. The reference torque is a motor load prior to the increase of motor load accompanying the conveyance of sheet.

The amount of paper dust transferred to the photosensitive drum 1 varies according to the path through which the sheet S passes before passing through the photosensitive drum 1. In the present embodiment, a period of time from starting of the feeding of the sheet S from the supporting portion, i.e., the sheet cassette 80 or the manual feed tray 81, to the arrival of the leading edge of the sheet S at the transfer nip N is referred to as period T1. An average value of load torque of the motor 200 during the period T1 is referred to as a torque during conveyance. The torque during conveyance refers to the motor load in a state where the motor load has been increased along with the conveyance of a sheet.

The conveyance load torque used for predicting the amount of generation of paper dust according to the present embodiment is a difference between the torque during conveyance and the reference torque, that is, a value calculated by the following Expression 1.

Conveyance load torque=torque during conveyance−reference torque (Expression 1)

The conveyance load torque represents a magnitude of a load applied to the motor 200 when the conveyance member conveys a sheet during image formation. The control unit B1 according to the present embodiment calculates the conveyance load torque based on a detection result of the detecting unit after the motor 200 has been started according to an image formation execution instruction and before the conveyance of the sheet is started, and a detection result of the detecting unit after the conveyance of the sheet is started. However, the method for calculating the conveyance load torque is not limited thereto.

As illustrated in FIG. 8, the reference torque is approximately equal between in a case where the sheet S is conveyed via the first conveyance path P1 (solid line) and in a case where the sheet S is conveyed via the second conveyance path P2 (broken line). Meanwhile, the torque during conveyance is greater in the case where the sheet S is conveyed via the first conveyance path P1 (solid line) than in the case where the sheet S is conveyed via the second conveyance path P2 (broken line). Therefore, the conveyance load torque of the case where the sheet S is conveyed via the first conveyance path P1 (solid line) is greater than the conveyance load torque of the case where the sheet S is conveyed via the second conveyance path P2 (broken line). This is because the minimum radius of curvature R1 of the first conveyance path P1 is smaller than the minimum radius of curvature R2 of the second conveyance path P2.

By changing the toner purge amount according to the conveyance load torque described above, a more appropriate amount of toner according to the amount of paper dust that occurs during image formation may be supplied to the blade nip 6N.

According to the present embodiment, in a case where the conveyance load torque exceeds a predetermined threshold value, a toner purge amount during post-rotation is changed. When the conveyance load torque exceeds a threshold value, the amount of toner to be supplied to the blade nip 6N by the toner purge operation is set greater than the amount of toner to be supplied to the blade nip 6N by the toner purge operation in a state where the conveyance load torque is equal to or smaller than the threshold value. In other words, when the control unit B1 determines that the load applied to the motor 200 is equal to or smaller than a threshold value, the control unit B1 sets the amount of toner to be supplied to the contact portion by the toner supplying operation to a first supply amount. When the control unit B1 determines that the load applied to the motor 200 is greater than the threshold value, the control unit B1 sets the amount of toner to be supplied to the contact portion by the toner supplying operation to a second supply amount greater than the first supply amount. The threshold value of the conveyance load torque is set to 100 mN m, for example.

The control unit B1 according to the present embodiments changes the amount of toner to be supplied to the blade nip 6N, i.e., contact portion, by the toner purge operation, i.e., toner supplying operation, by changing the width of the toner pattern, i.e., predetermined toner image, in the direction of rotation of the photosensitive drum 1. More specifically, in a state where the control unit B1 determines that the conveyance load torque is greater than the threshold value, the width of the toner pattern in the toner purge operation executed during post-rotation of the job is set to 10 mm. Meanwhile, in a state where the control unit B1 determines that the conveyance load torque is equal to or smaller than the threshold value, the width of the toner pattern in the toner purge operation executed during post-rotation of the job is set to 5 mm.

For example, in a case where the sheet cassette 80 is set as the supply source of the sheet S in the present embodiment, the conveyance load torque may exceed a threshold value, and a 10-mm-width toner pattern may be formed in the toner purge operation during post-rotation. Meanwhile, in a case where the manual feed tray 81 is set as the supply source of the sheet S, normally the conveyance load torque will be equal to or lower than the threshold value, and a 5-mm-width toner pattern is formed in the toner purge operation during post-rotation. That is, the amount of toner to be supplied to the blade nip 6N in the toner purge operation increases in a case where the sheet S is fed from the sheet cassette 80 than in a case where the sheet S is fed from the manual feed tray 81.

However, the conveyance load torque may be changed due to causes other than the conveyance paths. For example, the conveyance load torque may become smaller than the threshold value even when the sheet S is fed from the sheet cassette 80, due to the abrasion of the feed roller 84 and the registration roller pair 88. In this case, a 5-mm toner pattern is formed in the toner purge operation during post-rotation.

### Control Flow

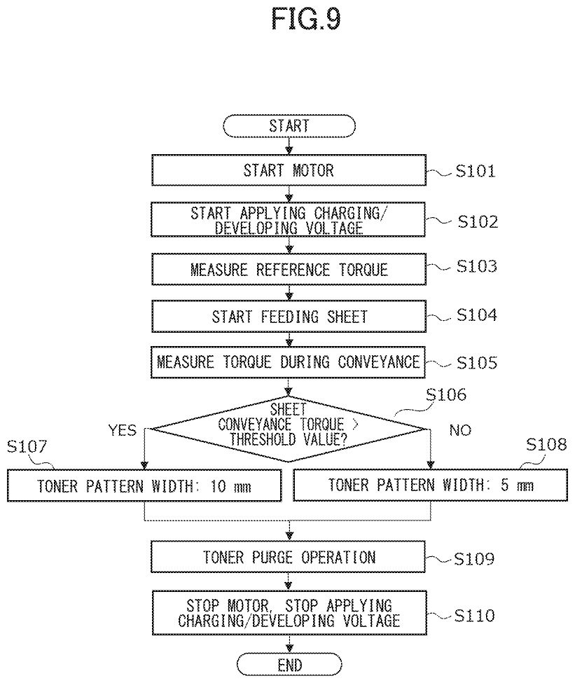

FIG. 9 is a flowchart illustrating an example of an execution sequence of an image forming job according to the first embodiment. The respective steps of the present flowchart are performed by the CPU of the control unit B1 (FIG. 3) executing a program read from the storage unit.

When an image forming job is entered by a user, the control unit B1 starts the present sequence based on the received image information and job information. The job information is information related to a designation of image forming condition that the user has selected when entering the job. The user can set the job information through an operation panel disposed on the image forming apparatus 100 or by operating a driver software screen of an external device connected to the image forming apparatus 100.

In S101, the control unit B1 starts the motor 200 (FIG. 3), by which the rotation of the photosensitive drum 1 is started. In S102, the control unit B1 executes a start processing, i.e., application start processing, of various bias voltages. Thereby, a charging voltage of −1100 V is applied to the charging roller 2, and a developing voltage of −400 V, for example, is applied to the developing roller 25.

In S103, the control unit B1 calculates the reference torque based on the load torque of the motor 200 during period TO from the motor start timing of S102 to the elapse of 500 ms, and stores the calculated reference torque in a nonvolatile memory in the control unit B1.

In S104, the control unit B1 starts to feed the sheet S from a supply source, i.e., the sheet cassette 80 or the manual feed tray 81, according to the designation of the job information. In other words, the control unit B1 starts the feeding operation by the pickup roller 82 and the feed roller 84 of the cassette sheet feed portion F1, or starts the feeding operation by the feed roller 89 of the manual sheet feed portion F2.

In S105, the control unit B1 calculates the torque during conveyance based on the load torque of the motor 200 during period T1 from the start timing of the feeding operation in S104 to the arrival of the leading edge of the sheet S at the transfer nip N. Further, the control unit B1 refers to the value of the reference torque stored in the nonvolatile memory, and calculates the conveyance load torque using Expression (1).

In S106, the control unit B1 compares the conveyance load torque with the threshold value. If it is determined in S106 that the conveyance load torque is greater than the threshold value, the control unit B1 sets the toner pattern width of the toner purge operation to 10 mm in S107. Meanwhile, if it is determined in S106 that the conveyance load torque is equal to or smaller than the threshold value, the control unit B1 sets the toner pattern width of the toner purge operation to 5 mm in S108.

In S109, the control unit B1 executes the toner purge operation during post-rotation in the present job. In this state, a toner pattern is formed according to a toner purge amount, i.e., toner pattern width, set in S107 or S108, and toner is supplied to the blade nip 6N.

In S110, the control unit B1 stops application of the charging voltage and the developing voltage, and after stopping the rotation of the motor 200, ends the image forming job sequence. Rotation of the motor 200 is stopped at a timing after the entire toner pattern formed by the toner purge operation has arrived at the blade nip 6N.

### Evaluation Experiment 1

An experiment described below was performed to evaluate a cleaning performance and a toner consumption amount according to the configuration of the present embodiment. Comparative examples 1 and 2 in which the toner purge amount in the toner purge operation is set to a fixed value regardless of the value of the conveyance load torque were prepared. In comparative example 1, the toner pattern width was fixed to 7.5 mm, and in comparative example 2, the toner pattern width was fixed to 10 mm.

According to the first embodiment, the toner pattern width in the toner purge operation performed after the image forming operation in which the sheet S is fed through the first conveyance path P1, i.e., cassette sheet feed path, in an intermittent printing operation was set to 10 mm. Further according to the first embodiment, the toner pattern width in the toner purge operation performed after the image forming operation in which the sheet S is fed through the second conveyance path P2, i.e., manual sheet feed path, in an intermittent printing operation was set to 5 mm.

Evaluation of cleaning performance was performed by confirming whether image defects called vertical stripes have occurred after intermittent printing operation in which test sheets are fed alternately through the first conveyance path P1, i.e., the sheet cassette 80, and the second conveyance path P2, i.e., the manual feed tray 81. The condition of experiment was an environment of 23 °C and 50%. Through intermittent printing operation, a test image having an image coverage of 2% was formed to a total of 30K, or 30000, test sheets. K represents×1000. That is, 1000 sheets equal 1K sheets, and this unit may be used in the following description. During execution of the intermittent printing operation, each time an image forming operation to one sheet S is finished, the toner purge operation was executed according to the toner pattern widths of the first embodiment or comparative example 1 or 2. A Red Label Presentation, which is manufactured by Canon, Inc., having a grammage of 80 g/m² was used as the sheet S. After the intermittent printing operation, a halftone image having an image coverage of 25% was output, and presence of vertical stripes within the halftone image was confirmed. Vertical stripes refer to unevenness of density that extends in a conveyance direction, i.e., sub-scanning direction during image formation, of the sheet S. In Table 1 illustrated below, “Good” indicates that vertical stripes did not occur, and “Poor” indicates that vertical stripes have occurred, i.e., vertical stripes of a level that is recognized as a problem regarding image quality have been visually confirmed.

The evaluation of toner consumption amount was performed by repeatedly forming a predetermined test image in a state where a predetermined amount of toner is filled in the toner storage chamber 31a, and recording an accumulated number of printed sheets before a void occurs in the image by depletion of toner as “number of sheets before occurrence of void”. The void in an image refers to image defects in which a part of the halftone toner image is missing and a blank area or white spot appears.

Table 1 shows the setting of toner purge amount, i.e., toner pattern width in the toner purge operation according to comparative examples 1 and 2 and the first embodiment, and evaluation results of cleaning performance and toner consumption amount, i.e., number of sheets before occurrence of void.

TABLE 1

| | COMPARATIVE | COMPARATIVE | FIRST |
|---|---|---|---|
| | EXAMPLE 1 | EXAMPLE 2 | EMBODIMENT |
| TONER PURGE AMOUNT | 7.5 mm | 10 mm | 5 mm/10 mm |
| (TONER PATTERN WIDTH) | | | |
| EVALUATION OF CLEANING | Poor | Good | Good |
| PERFORMANCE: | | | |
| PRESENCE OF VERTICAL STRIPES | | | |
| EVALUATION OF TONER | 41 | 36 | 41 |
| CONSUMPTION AMOUNT: | | | |
| NUMBER OF SHEETS BEFORE | | | |
| OCCURRENCE OF VOID (1000 SHEETS) | | | |

As illustrated in Table 1, according to the comparative example 1, the evaluation of cleaning performance was “Poor”. This is considered to be caused by the reformation of the lubricating layer 6a being insufficient during image formation under a condition where a large amount of paper dust is generated in a case where the toner pattern width in the toner purge operation is fixed to 7.5 mm.

For example, in a case where the sheet S is fed through the first conveyance path P1, i.e., cassette sheet feed path, in intermittent printing operation, the conveyance load torque is increased, and a relatively large amount of paper dust is generated. In this case, the reduction of the lubricating layer 6a is advanced by the influence of paper dust, such that even if a toner pattern having a width of 7.5 mm is supplied to the blade nip 6N by toner purge operation, reformation of the lubricating layer 6a may be insufficient. For example, during execution of intermittent printing operation, when a subsequent image forming operation is started in a state where the lubricating layer 6a is insufficient, the cleaning blade may be turned-up or chipped, by which paper dust and external additives of toner may pass through the cleaning blade 6. Then, paper dust and external additives of toner are accumulated along the circumferential direction of the charging roller 2. As a result, vertical stripes caused by charging failure are considered to have occurred on the halftone image after performing intermittent printing operation of 30K sheets.

Further, since the deterioration of cleaning performance was similarly generated according to comparative example 1, the deterioration of cleaning performance will clearly become even more significant if the toner pattern width is fixed to 5 mm, i.e., the evaluation of cleaning performance will be “Poor”.

In comparative example 2, even though the evaluation of cleaning performance was “Good”, the number of sheets before occurrence of void was reduced from 41K sheets of comparative example 1 to 36K sheets. This means that even during conveyance of sheets through the first conveyance path P1, i.e., cassette sheet feed path, according to which a large amount of paper dust is generated, if the toner pattern having a width of 10 mm is supplied to the blade nip 6N by toner purge operation, the deterioration of cleaning performance could be suppressed. Meanwhile, even during conveyance of sheets through the second conveyance path P2, i.e., manual sheet feed path, where the conveyance load torque is small and the amount of generated paper dust is small, toner corresponding to a toner pattern having a 10-mm width will be constantly consumed by toner purge operation. That is, toner is not used for the image forming operation but consumed in a state not contributing to the maintenance of cleaning performance. As a result, in comparative example 2, the number of sheets before occurrence of void was reduced compared to comparative example 1.

In contrast, according to the first embodiment, the evaluation of cleaning performance was “Good”, and the number of sheets before occurrence of void was 41K sheets, equivalent to the comparative example 1.

According to the first embodiment, in the toner purge operation after the image forming operation in which the sheet S is fed through the first conveyance path P1, i.e., cassette sheet feed path, a 10-mm-width toner pattern is supplied to the blade nip 6N by toner purge operation. Therefore, it is considered that similar to comparative example 2, even during sheet conveyance through the first conveyance path P1, i.e., cassette sheet feed path, in which a large amount of paper dust is generated, the lubricating layer 6a was maintained, and the deterioration of cleaning performance was suppressed. It is considered that in the toner purge operation after the image forming operation in which the sheet S is fed through the second conveyance path P2, i.e., manual sheet feed path, in which a small amount of paper dust occurs, a sufficient lubricating layer 6a could be maintained even by a toner pattern having a 5-mm width, and the cleaning performance was maintained.

That is, according to the first embodiment, the deterioration of cleaning performance by depletion of the lubricating layer 6a can be prevented.

According further to the first embodiment, compared to comparative example 2, the amount of toner consumption by the toner purge operation after the image forming operation in which the sheet S is fed through the second conveyance path P2, i.e., manual sheet feed path, was small. That is, according to the first embodiment, toner consumption that is not used for the image forming operation and that does not contribute to the maintenance of the cleaning performance is suppressed. As a result, according to the first embodiment, the number of sheets before occurrence of void, that is, the number of sheets on which image can be output by the image forming apparatus 100 before the toner of the toner storage chamber 31a is depleted, was improved compared to the comparative example 2.

That is, according to the first embodiment, the reduction of the printable number of sheets by excessive toner consumption by the toner purge operation can be prevented.

Further, when the first embodiment and the comparative example 1 are compared, even though the accumulated toner consumption amounts by the toner purge operation executed during the period of intermittent printing operation were approximately the same, according to the first embodiment, the deterioration of cleaning performance was suppressed compared to comparative example 1. This means that by changing the toner purge amount according to the difference in conveyance paths, toner can be utilized more effectively for image formation and for maintaining the cleaning performance.

That is, according to comparative example 1, the toner purge amount is insufficient when sheets are fed through the first conveyance path P1, i.e., cassette sheet feed path, and the toner purge amount is excessive when sheets are fed through the second conveyance path P2, i.e., manual sheet feed path. According to the first embodiment, the lack of toner purge amount when sheets are fed through the first conveyance path P1 in comparative example 1 is compensated using the excessive part of the toner purge amount when sheets are fed through the second conveyance path P2 in comparative example 1.

As described, according to the first embodiment, the reduction of printable number of sheets through excessive toner consumption by the toner purge operation may be suppressed, while the deterioration of cleaning performance by depletion of the lubricating layer 6a may also be suppressed.

### Summary of Present Embodiment

A lubricating layer by external additives of toner is formed at the contact portion between the cleaning member and the photosensitive drum. The lubricating layer contributes to enhancing the cleaning performance by improving the lubricating ability of the cleaning member and suppressing the passing through of toner.

However, even if an operation to supply toner to the contact portion between the cleaning member and the photosensitive drum is performed when image is not formed to prevent depletion of the lubricating layer, excess or deficiency of toner supplied to the contact portion may still occur depending on the conditions of the image forming operation.

As described above, according to the present embodiment, the toner purge amount of the toner purge operation is changed based on the load torque of the motor 200 during image formation. In other words, the control unit B1 changes the amount of toner to be supplied to the contact portion by the toner supplying operation based on the detection result of the detecting unit in a state where the conveyance member is conveying the sheet in the image forming operation. The control unit B1 changes the amount of toner to be supplied to the contact portion by the toner supplying operation based on the detection result of the detecting unit, such that: (1) a first supply amount of toner is supplied to the contact portion by the toner supplying operation in a case where a first load is applied to the motor 200 by the conveyance member conveying the sheet in an image forming operation; and (2) a second supply amount, which is greater than the first supply amount, of toner is supplied to the contact portion by the toner supplying operation in a case where a second load greater than the first load is applied to the motor 200 by the conveyance member conveying the sheet in an image forming operation.

An example of the first load is the load of the motor 200 when a sheet S is conveyed via the second conveyance path P2 using the sheet described in evaluation experiment 1. An example of the second load is the load of the motor 200 when a sheet S is conveyed via the first conveyance path P1 using the sheet described in evaluation experiment 1. Further, the examples of the first supply amount and the second supply amount correspond to the toner purge amounts of cases where the toner pattern widths are set to 5 mm and 10 mm, respectively, according to the first embodiment.

Thereby, an image forming apparatus capable of supplying a more appropriate amount of toner to the contact portion, i.e., the blade nip 6N, between the cleaning member and the photosensitive drum can be provided.

As described earlier, the amount of generation of paper dust during image formation has a correlation with the magnitude of load torque of the motor 200. For example, in a case where the amount of generation of paper dust differs according to the difference in conveyance paths of the sheet S within the image forming apparatus 100, by changing the toner purge amount according to the load torque of the motor 200, a more appropriate amount of toner may be supplied to the contact portion, i.e., the blade nip 6N. Further, even in a case where the amount of generation of paper dust differs according to causes other than the difference in conveyance paths, such as the abrasion of the conveyance member or the difference in grammage of the sheets S, the amount of generation of paper dust can be predicted based on the load torque of the motor 200. Even according to such a case, a more appropriate amount of toner can be supplied to the contact portion, i.e., the blade nip 6N, by changing the toner purge amount according to the load torque of the motor 200.

### Modified Example

In the first embodiment, an example of using the current detecting unit 239 for detecting a coil current as the detecting unit for detecting information regarding the load applied to the motor was described, but the example of the detecting unit is not limited thereto. For example, a torque sensor attached to an output shaft of the motor 200 may be adopted as the detecting unit.

In the first embodiment, an example of changing the toner purge amount by comparing the value of the conveyance load torque itself with the threshold value set in advance was described, but the method for changing the toner purge amount based on the detection result of information related to the load on the motor 200 is not limited thereto. For example, it is known that the tendency of generation of paper dust differs according to the sheet material, i.e., grammage, or environmental conditions, such as temperature and humidity. Therefore, the toner purge amount may be changed by comparing a value obtained by multiplying the conveyance load torque detected during image formation by a coefficient according to the sheet material or the environmental conditions during image formation with the threshold value set in advance.

Further, an example of determining the toner purge amount by converting the coil current into a load torque of the motor 200 and comparing the load torque with a threshold value according to the first embodiment was described as a control method for changing the toner purge amount based on the detection result of the detecting unit. The method is not limited to the above-described method, and for example, the coil current, or a q-axis current, may be compared directly with a threshold value for determining the toner purge amount, and the toner purge amount may be determined based on the comparison result.

The method for changing the toner purge amount is not limited to changing the toner pattern width in the direction of rotation of the photosensitive drum 1, and it may be performed by changing the toner pattern density, i.e., amount of toner per unit area on the surface 1a of the photosensitive drum 1. Further, in a case where a plurality of parallel lines aligned in the rotational axis direction X of the photosensitive drum 1 and also aligned in the direction of rotation of the photosensitive drum 1 are used as a toner pattern, the number of lines of the parallel lines may be changed.

In the first embodiment, a case where the toner purge amount is changed in two steps to a 5-mm width and a 10-mm width has been described, but it is also possible to change the toner purge amount in three or more steps using a plurality of threshold values. Further, the method is not limited to the method of selecting a toner purge amount from steps set in advance, and a configuration may be adopted in which a toner purge amount is determined according to the image forming condition, such that the toner purge amount takes an arbitrary value within a successive numerical range.

In the first embodiment, an example in which the toner purge operation is executed during post-rotation has been described, but the toner purge operation may also be executed when image is not formed and at a timing other than the post-rotation operation. For example, in a continuous image forming job, i.e., continuous print job, in which a plurality of sheets S are continuously conveyed while having images formed thereon, the toner purge operation may be executed at a final sheet interval of the job, that is, a sheet interval that occurs immediately before transferring the last toner image of a job. According to this configuration, similar to the case in which a toner purge operation is executed during post-rotation, the lubricating layer 6a can be reformed before a point of time when the current job ends. Therefore, the turning-up or chipping of the cleaning blade 6 when the rotation of the photosensitive drum 1 is started in a state where a subsequent job is entered may be suppressed effectively, such that advantages similar to those of the embodiment described above may be obtained.

### Second Embodiment

A control regarding a toner purge operation in a continuous print job will be described as a second embodiment. A configuration in which a shape of a toner pattern in the toner purge operation differs from the first embodiment will be described. Hereafter, components assigned with the same reference number as the first embodiment have basically a same configuration and same effect as those described in the first embodiment unless denoted otherwise, and portions that differ from the first embodiment will mainly be described below.

As described above, after the photosensitive drum 1 has stopped in a state where the lubricating layer 6a is reduced, if a subsequent image forming job is entered and rotation of the photosensitive drum 1 is started, turning-up and chipping of the cleaning blade 6 tends to occur. However, since the lubricating layer 6a is gradually reduced by each image forming operation, turning-up and chipping of the cleaning blade 6 may occur even during a period in which the photosensitive drum 1 is driven continuously in a continuous print job.

Therefore, according to the first embodiment, the toner purge operation is executed at the time of post-rotation, whereas according to the second embodiment, the toner purge operation is executed even in a sheet interval during continuous printing based on a sum St of conveyance load torque defined below. St (n) represents a sum of conveyance load torque (mN m) from the first to nth sheets, and T (n) represents a conveyance load torque (mN m) of the first sheet S.

St(N)=T×N (Expression 2)

In the above Expression 2, it is assumed that the conveyance load torque of the second and subsequent sheets S in the continuous print job is equivalent to the conveyance load torque of the first sheet S. This is because in the continuous print job, the conveyance operations of a plurality of sheets S are advanced in an overlapped manner on the timeline, such that the first sheet S allows the conveyance load torque corresponding to one sheet S to be detected correctly.

However, in a case where the conveyance load torque corresponding to one sheet S can be detected, the sum of conveyance load torques that have been detected for each of the second and subsequent sheets S in the continuous print job can be set as the sum St of the conveyance load torque. For example, a feeding motor that drives the pickup roller 82 and the feed roller 84 may be arranged independently from the motor that drives the other conveyance members. In that case, it may be possible to detect the conveyance load torque of the feeding motor during conveyance of each sheet S of the continuous print job, and to set the sum thereof as the sum St of the conveyance load torque.

That is, according to the second embodiment, if it is determined that a predetermined amount of paper dust or more has possibly reached the blade nip 6N during continuous printing, a toner purge operation during sheet intervals is performed to strengthen the lubricating layer 6a. Hereafter, the toner purge operation at the sheet interval during continuous printing may be referred to as a “sheet interval toner purge”

A sheet interval during continuous printing refers to an interval after the trailing edge of the previous sheet S in a continuous print job has passed through the transfer nip N and before a leading edge of the subsequent sheet S enters the transfer nip N. The sheet interval during continuous printing is one example of a timing when image is not formed.

Further, as described above, the execution timing of toner purge operation is based on a timing at which a point focused on the surface 1a of the photosensitive drum 1 passes through the transfer nip N. Therefore, if the toner pattern formed by the toner purge operation has passed through the transfer nip N during a period of time from the passing of the trailing edge of the previous sheet S through the transfer nip N to the entry of a leading edge of the subsequent sheet S to the transfer nip N, the toner purge operation is described as being executed during a sheet interval. In that case, the scanner unit 3 can start exposure of the photosensitive drum 1 to form a toner pattern before the trailing edge of the previous sheet S passes through the transfer nip N.

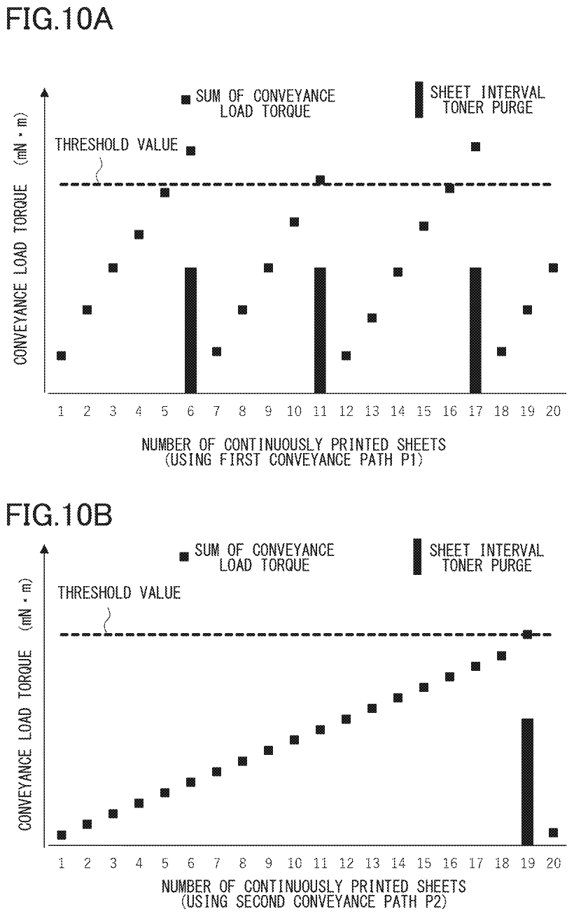

A control of sheet interval toner purge according to a sum of conveyance load torque will be described with reference to FIGS. 10A and 10B. FIG. 10A illustrates a sum of a conveyance load torque and an execution timing of a sheet interval toner purge in a case where a continuous print job is executed using the sheet S conveyed via the first conveyance path P1. FIG. 10B illustrates a sum of a conveyance load torque and an execution timing of a sheet interval toner purge in a case where a continuous print job is executed using the sheet S conveyed via the second conveyance path P2. The horizontal axes of FIGS. 10a and 10b each indicate an accumulated number of sheets of image output, i.e., number of continuously printed sheets, in a continuous print job. The points of FIGS. 10A and 10B each indicate the sum of conveyance load torque, the dotted lines each indicate a threshold value of sheet interval toner purge, and the vertical bars each indicate that the sheet interval toner purge is executed at a sheet interval between a sheet and a subsequent sheet.

In the present embodiment, in a state where the sum of conveyance load torque exceeds the threshold value set in advance, i.e., threshold value of sheet interval toner purge, the sheet interval toner purge is executed. The threshold value of sheet interval toner purge is set, for example, to 500 (mN m). In a state where the sheet interval toner purge is executed, the sum of conveyance load torque is reset to 0.

As illustrated in FIG. 10A, in a state where a continuous print job is executed using the sheet S conveyed via the first conveyance path P1, the sum of conveyance load torque exceeds the threshold value by the conveyance of the sixth sheet S. Meanwhile, the conveyance load torque in a case where the sheet S is conveyed via the second conveyance path P2 is smaller than in a case where the sheet S is conveyed via the first conveyance path P1. Therefore, as illustrated in FIG. 10B, in a case where the continuous print job is executed using the sheet S conveyed via the second conveyance path P2, the increase of sum of the conveyance load torque becomes gentle, such that the sum of conveyance load torque exceeds the threshold value by the conveyance of the 19th sheet S.

As described above, by executing the sheet interval toner purge based on a sum of conveyance load torque, a more appropriate amount of toner may be supplied to the blade nip 6N according to the predicted amount of generation of paper dust. Thereby, depletion of the lubricating layer 6a during continuous printing may be prevented while suppressing toner consumption.

### Control Flow

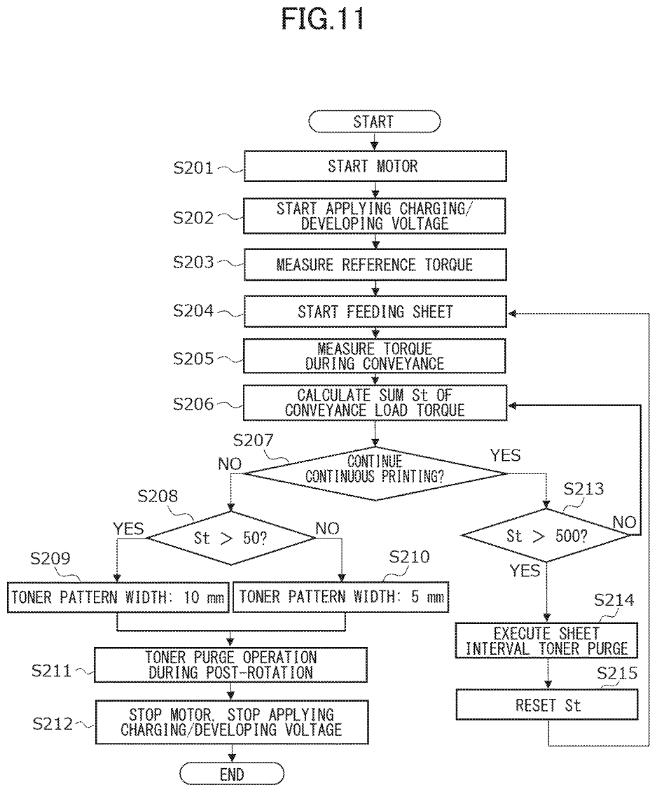

FIG. 11 is a flowchart illustrating an example of execution sequence of an image forming job according to the second embodiment. The respective steps of the present flowchart are performed by the CPU of the control unit B1 (FIG. 3) executing a program read from the storage unit.

The processes of S201 to S205 are similar to the processes of S101 to S105 according to the flow (FIG. 5) of the first embodiment, such that descriptions thereof are omitted. In S206, the control unit B1 calculates a sum of the conveyance load torque and stores the same in a nonvolatile memory within the control unit B1. In S207, the control unit B1 determines whether to continue execution of the continuous print job, i.e., whether there is a sheet S on which image is to be formed.

If it is determined in S207 that the continuous print job is not to be continued, that is, that the job is ended, the control unit B1 compares the sum of the conveyance load torque at that point of time with a threshold value of toner purge operation during post-rotation, such as 50 mN m, in S208. If the sum of the conveyance load torque is greater than the threshold value in S208, the control unit B1 sets the toner pattern width to 10 mm in S209, and executes the toner purge operation during post-rotation in S211. If the sum of the conveyance load torque is determined to be equal to or smaller than the threshold value in S208, the control unit B1 sets the toner pattern width to 5 mm in S210, and executes the toner purge operation during post-rotation in S211. In S212, the control unit B1 stops application of charging voltage and developing voltage, stops rotation of the motor 200, and thereafter, ends the image forming job sequence.

If it is determined in S207 that the continuous print job is to be continued, the control unit B1 compares the sum of the conveyance load torque at that point of time with a threshold value of sheet interval toner purge, such as 500 mN m, in S213. If the sum of the conveyance load torque is determined to be equal to or smaller than the threshold value, the control unit B1 determines that the sheet interval toner purge is not to be executed, and returns to S206 and updates the sum of the conveyance load torque. If the sum of the conveyance load torque is greater than the threshold value in S213, the control unit B1 determines that the sheet interval toner purge is to be executed, and executes the sheet interval toner purge at an executable timing (S214). For example, if the sum of the conveyance load torque exceeded the threshold value for the first time at the tenth sheet S in the continuous print job, the sheet interval toner purge is executed at the sheet interval between the tenth sheet S and the eleventh sheet S. Further, in a case where the sheet interval toner purge is executed, the control unit B1 resets the sum of the conveyance load torque in S215, and then returns to S204 to start the feeding operation of the next sheet S.

The contents of the sheet interval toner purge executed in S214 are similar to the toner purge operation performed during post-rotation described in the first embodiment, except that the execution timings differ. The toner pattern width in the sheet interval toner purge is set to 10 mm, for example. The amount of toner to be supplied to the blade nip 6N by the sheet interval toner purge may differ from the toner purge operation during post-rotation.

The threshold value of the sheet interval toner purge may differ from 500 mN m. If the threshold value of sheet interval toner purge is set high, the frequency of execution of the sheet interval toner purge is reduced. The threshold value of the sheet interval toner purge and the threshold value of the toner purge operation during post-rotation may be different values. The threshold value of the sheet interval toner purge and the threshold value of the toner purge operation during post-rotation, and the toner purge amount during the sheet interval toner purge may be changed according to the environment of use of the image forming apparatus 100 and the configuration of the process cartridge 70.

### Evaluation Experiment 2

In order to evaluate the cleaning performance and the toner consumption amount according to the configuration of the present embodiment, experiments were performed by an experiment method similar to the evaluation experiment 1, except for the following points of the intermittent printing operation. In this experiment, in addition to a method for switching the conveyance paths of the sheets S for each sheet between the first conveyance path P1 and the second conveyance path P2 similar to evaluation experiment 1, i.e., one-sheet intermittency, a method for switching conveyance paths of the sheets S every fifty sheets, i.e., 50-sheet intermittency, was performed. The 50-sheet intermittency refers to a method in which after 50 sheets S are continuously conveyed via the first conveyance path P1, 50 sheets S are then continuously conveyed via the second conveyance path P2, and the conveyance paths of the sheets S are switched similarly every 50 sheets thereafter. The other processes of the intermittent printing operation, the evaluation method and evaluation reference of the cleaning performance and the toner consumption amount are the same as those of the evaluation experiment 1. In the evaluation of the cleaning performance, “Fair” refers to a state where slight vertical stripes of a level that is not considered as a problem of image quality have been visually confirmed.

TABLE 2

| | FIRST | | SECOND |
|---|---|---|---|
| | EMBODIMENT | | EMBODIMENT |
| SHEET INTERVAL | N | | Y |
| TONER PURGE | | | |
| PRINTING MODE | ONE-SHEET | 50-SHEET | 50-SHEET |
| | INTERMITTENCY | INTERMITTENCY | INTERMITTENCY |
| EVALUATION OF CLEANING | Good | Fair | Good |
| PERFORMANCE: | | | |
| PRESENCE OF VERTICAL STRIPES | | | |
| EVALUATION OF TONER | 41 | 46 | 45 |
| CONSUMPTION AMOUNT: | | | |
| NUMBER OF SHEETS BEFORE | | | |
| OCCURRENCE OF VOID (1000 SHEETS) | | | |

In the first embodiment, the evaluation of the cleaning performance in a case where an intermittent printing operation of one-sheet intermittency similar to the evaluation experiment 1 was “Good”, and the number of sheets before occurrence of void was 41K sheets, equivalent to the comparative example 1. However, the evaluation of the cleaning performance in a case where an intermittent printing operation of a 50-sheet intermittency was performed according to the first embodiment was “Fair (with slight vertical stripes)”. This is considered to be cause by the occurrence of pass-through of toner and external additives due to the depletion of the lubricating layer 6a during continuous printing, since the toner purge operation during post-rotation is not performed until continuous printing of 50 sheets has been completed according to the first embodiment.

Meanwhile, in the second embodiment, the evaluation of the cleaning performance in a case where an intermittent printing operation of 50-sheet intermittency was “Good (without vertical stripes)”. When an intermittent printing operation of 50-sheet intermittency was executed according to the second embodiment, the sheet interval toner purge was executed for seven to nine times during a continuous printing of 50 sheets via the first conveyance path P1, i.e., cassette sheet feed path. Further, when an intermittent printing operation of 50-sheet intermittency was executed according to the second embodiment, the sheet interval toner purge was executed for zero to one time(s) during a continuous printing of 50 sheets via the second conveyance path P2, i.e., manual sheet feed path. Thus, it is considered that the depletion of the lubricating layer 6a during continuous printing was suppressed, and a good cleaning performance was maintained.

In the first embodiment, in a state where an intermittent printing operation of 50-sheet intermittency was performed, the frequency of toner purge operation was reduced compared to the case of a one-sheet intermittency, such that the number of sheets before occurrence of void was improved from 41 K sheets to 46K sheets. In the second embodiment, the sheet interval toner purge was executed during continuous printing, such that the number of sheets before occurrence of void were somewhat deteriorated compared to the 50-sheet intermittency of the first embodiment, and the number was 45K sheets, which is at least greater than the case of the one-sheet intermittency.

As described, according to the second embodiment, it is possible to suppress the reduction of the printable number of sheets by excessive toner consumption during the toner purge operation, and to suppress the deterioration of cleaning performance by the depletion of the lubricating layer 6a. Specifically, the deterioration of cleaning performance by the depletion of the lubricating layer 6a during continuous printing may be prevented.

### Summary of Present Embodiment

As described above, according to the present embodiment, whether to execute the sheet interval toner purge is determined based on the sum of conveyance load torque during execution of a continuous print job. In other words, the control unit B1 can execute a toner supplying operation such that a predetermined toner image passes through a transfer portion during a period of time from the passing of the previous sheet through the transfer portion to the arrival of the subsequent sheet at the transfer portion, during execution of a job of executing the image forming operation to a plurality of sheets while conveying the sheets continuously. Further, the control unit B1 determines whether to execute the toner supplying operation during the above period of time, i.e., sheet interval, based on the accumulated value of load applied to the motor by conveyance of the respective sheets during the job.

Thereby, it becomes possible to suppress the reduction of the printable number of sheets by excessive toner consumption during the toner purge operation, and to suppress the deterioration of the cleaning performance by the depletion of the lubricating layer 6a. Specifically, according to the present embodiment, the deterioration of cleaning performance by the depletion of the lubricating layer 6a during continuous printing may be prevented.

Supposing that a configuration of executing the sheet interval toner purge each time the number of continuously printed sheets has exceeded the number of sheets set in advance is adopted, the sheet interval toner purge is executed by a fixed frequency during continuous printing via a conveyance path according to which the motor load is small and paper dust is less likely to occur. In that case, toner is consumed in a manner not contributing to maintaining the cleaning performance, such that the number of sheets before occurrence of void or the printable number of sheets are reduced. Further, according to the configuration of executing the sheet interval toner purge each time the number of continuously printed sheets has exceeded the number of sheets set in advance, the sheet interval toner purge is executed by a fixed frequency during continuous printing via a conveyance path according to which the motor load is great and paper dust is likely to occur. In that case, the depletion of the lubricating layer 6a during continuous printing cannot be suppressed, and the deterioration of cleaning performance may occur. According to the present embodiment, the sheet interval toner purge may be executed at an appropriate timing by determining the execution of the sheet interval toner purge during continuous printing based on the detection result of motor load.

### Modified Example

A calculation method of the sum, i.e., accumulated value, of conveyance load torque is not limited to that described in the first embodiment. For example, the likeliness of generation of paper dust is known to differ according to the sheet material, i.e., grammage, and environmental conditions, such as temperature and humidity. Therefore, it may be possible to integrate a value obtained by multiplying the conveyance load torque of each sheet during continuous printing by a coefficient according to the material of the sheet or the environmental conditions during conveyance of the sheets.

### Other Modifications

The present disclosure is not limited to the embodiments described above, and for example, all or a portion of the above-mentioned embodiments may be combined and executed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067693, filed Apr. 16, 2025, which is hereby incorporated by reference herein in its entirety.

What is claimed is:

1. An image forming apparatus comprising:
a photosensitive drum configured to rotate;
a transfer member configured to form a transfer portion at which a toner image is transferred from the photosensitive drum to a sheet;
a cleaning member configured to come into contact with the photosensitive drum and remove toner that has not been transferred to the sheet at the transfer portion from a surface of the photosensitive drum;
a conveyance member configured to convey a sheet;
a motor configured to drive the conveyance member;
a detecting unit configured to detect information regarding a load applied to the motor; and
a control unit configured to execute (i) an image forming operation in which a toner image formed on the surface of the photosensitive drum is transferred to a sheet at the transfer portion, and (ii) a toner supplying operation which differs from the image forming operation and in which a predetermined toner image formed on the surface of the photosensitive drum is passed through the transfer portion such that toner is supplied to a contact portion between the cleaning member and the photosensitive drum,
wherein the control unit is configured to change an amount of toner to be supplied to the contact portion by the toner supplying operation based on a detection result of the detecting unit, such that:
(1) a first supply amount of toner is supplied to the contact portion by the toner supplying operation in a case where a first load is applied to the motor by the conveyance member conveying a sheet in the image forming operation; and
(2) a second supply amount, which is greater than the first supply amount, is supplied to the contact portion by the toner supplying operation in a case where a second load that is greater than the first load is applied to the motor by the conveyance member conveying a sheet in the image forming operation.

2. The image forming apparatus according to claim 1, wherein, upon receiving an image forming job from a user, the control unit is configured to execute the toner supplying operation during a period of time after toner images have been transferred to all of the number of sheets designated by the user and before rotational driving of the photosensitive drum is stopped.

3. The image forming apparatus according to claim 1, wherein the control unit is configured to:
execute the toner supplying operation during execution of a job of conveying a plurality of sheets continuously while executing the image forming operation to each sheet, such that the predetermined toner image passes through the transfer portion during a period of time after a previous sheet has passed through the transfer portion and before a subsequent sheet arrives at the transfer portion; and
determine whether to execute the toner supplying operation during the period of time based on an accumulated value of load applied to the motor by conveying each sheet in the job.

4. The image forming apparatus according to claim 1, wherein the detecting unit includes a current detecting unit configured to detect a current supplied to a coil of the motor.

5. The image forming apparatus according to claim 4,
wherein the motor is a brushless motor including a stator including a plurality of coils, and a rotor including a permanent magnet, and
wherein the control unit is configured to acquire a load applied to the motor based on a current supplied to the plurality of coils.

6. The image forming apparatus according to claim 1, wherein, based on the detection result of the detecting unit, the control unit is configured to:
set the amount of toner to be supplied to the contact portion by the toner supplying operation to the second supply amount in a case where the load applied to the motor by the conveyance member conveying a sheet is greater than a predetermined threshold value; and
set the amount of toner to be supplied to the contact portion by the toner supplying operation to the first supply amount in a case where the load applied to the motor is equal to or smaller than the threshold value.

7. The image forming apparatus according to claim 6, wherein the control unit is configured to determine the load applied to the motor by the conveyance member conveying a sheet based on a detection result of the detecting unit after the motor is started according to an execution instruction of image formation and before a conveyance of a sheet is started, and on a detection result of the detecting unit after the conveyance of the sheet is started.

8. The image forming apparatus according to claim 1, wherein the control unit is configured to change the amount of toner to be supplied to the contact portion by the toner supplying operation by changing a width of the predetermined toner image in a direction of rotation of the photosensitive drum.

9. The image forming apparatus according to claim 1, further comprising:
a first conveyance path through which a sheet conveyed toward the transfer portion passes; and
a second conveyance path through which a sheet conveyed toward the transfer portion via a path that differs from the first conveyance path passes,
wherein a minimum radius of curvature of the first conveyance path differs from a minimum radius of curvature of the second conveyance path.

10. The image forming apparatus according to claim 9, further comprising:
an apparatus body accommodating the photosensitive drum and the transfer member;
a supporting portion attached to the apparatus body so as to be drawable therefrom and configured to support a sheet; and
a manual feed tray protruding from the apparatus body and allow a user to set a sheet from outside the apparatus body,
wherein the image forming apparatus is configured such that the sheet supported on the supporting portion is conveyed to the transfer portion via the first conveyance path, and the sheet set on the manual feed tray is conveyed to the transfer portion via the second conveyance path.
